(19) United States
(12) Patent Application Publication
(10) Pub. No.: US 2025/0384091 A1
(43) Pub. Date: Dec. 18, 2025

(54) DOCUMENT SEARCH METHOD AND DOCUMENT SEARCH SYSTEM

(71) Applicant: Semiconductor Energy Laboratory Co., Ltd., Atsugi-shi, Kanagawa-ken (JP)

(72) Inventors: Junpei MOMO, Sagamihara (JP); Natsuko TAKASE, Isehara (JP)

(21) Appl. No.: 19/109,154

(22) PCT Filed: Oct. 16, 2023
(86) PCT No.: PCT/IB2023/060394

§ 371 Date: Mar. 6, 2025

(30) Foreign Application Priority Data
Oct. 21, 2022 (JP) 2022-169261

(51) Int. Cl. G06F 16/93

(52) U.S. Cl. CPC G06F 16/93

(57) ABSTRACT

To carry out a search for a document efficiently, a plurality of pieces of document data are received, a search query is received, each of the plurality of pieces of document data is evaluated on the basis of the search query, an evaluation result of at least part of the plurality of pieces of document data is output, classification of at least part of the plurality of pieces of document data is received, importance of a plurality of tags is inferred from the classification, the importance of at least part of the plurality of tags is output, at least one of the tags whose importance is output is received, and a search for a document is performed with use of the received tag.

### TECHNICAL FIELD

One embodiment of the present invention relates to a document search system. One embodiment of the present invention relates to a document search method. One embodiment of the present invention relates to a method for outputting a document search result. One embodiment of the present invention relates to a method for displaying a document search result.

Note that one embodiment of the present invention is not limited to the above technical field. Examples of the technical field of one embodiment of the present invention include a semiconductor device, a display device, a light-emitting device, a power storage device, a storage device, an electronic device, a lighting device, an input device (e.g., a touch sensor), an input/output device (e.g., a touch panel), a method for driving any of them, and a method for manufacturing any of them.

### BACKGROUND ART

Examples of tasks relating to patents include the prior art search, acquisition of patent right, and patent invalidity search. Prior art search for an invention before its application enables the confirmation whether or not there is a relevant intellectual property right. Domestic or foreign patent documents, papers, and the like found through the prior art search are helpful in confirming the novelty and non-obviousness of the invention and determining whether to file the application. In addition, patent invalidity search is conducted on the patent documents, whereby it is possible to find whether there is a possibility of invalidation of the patent right owned by an applicant or whether the patent rights owned by others can be rendered invalid.

Since the tasks relating to patents are wide-ranging, support systems for the tasks related to patents, such as a support system for creating patent application documents, a patent-information analysis system, and a patent search system, have been developed in recent years. Patent Document 1 discloses a patent document search technology that is a combination of the keyword search and the similarity search.

### REFERENCE

### Patent Document

[Patent Document 1] Japanese Published Patent Application No. 2018-73309

### SUMMARY OF THE INVENTION

### Problems to be Solved by the Invention

Use of a PageRank system, like a web search, lacks the objectivity in a search for the contents of a document. In addition, with respect to the meaning of one word, a plurality of expressions (e.g., Japanese phonetic scripts such as hiragana and katakana, kanji of Chinese characters, a representative word, a synonym, a broader term, and a narrower term) can be present, which makes it difficult to select a search keyword as appropriate. Moreover, patent documents are classified on the basis of technical matters, with use of the patent classification such as CPC (Cooperative Patent Classification), IPC (International Patent Classification), FI (File Index), or F terms (File Forming Term); their classification codes have an enormous number of items, which makes it difficult to appropriately select a classification code.

An object of one embodiment of the present invention is to provide a document search system, a document search method, or a method for outputting a document search result, which is of intuitiveness and efficient for a user. Another object of one embodiment of the present invention is to provide a document search system, a document search method, or a method for outputting a document search result, which can be operated easily by a user. Another object of one embodiment of the present invention is to provide a document search system, a document search method, or a method for outputting a document search result, which enables a user to obtain needed information efficiently.

Note that the description of these objects does not preclude the existence of other objects. One embodiment of the present invention does not necessarily need to achieve all of these objects. Other objects can be derived from the description of the specification, the drawings, and the claims.

### Means for Solving the Problems

One embodiment of the present invention is a document search method including a first step of receiving a plurality of pieces of document data, a second step of receiving a search query, a third step of evaluating each of the plurality of pieces of document data on the basis of the search query, a fourth step of outputting an evaluation result of at least a part of the plurality of pieces of document data, a fifth step of receiving classification of at least the part of the plurality of pieces of document data, a sixth step of inferring importance of each of a plurality of tags from the classification, a seventh step of outputting the importance of at least a part of the plurality of tags, an eighth step of receiving at least one of the tags whose importance is output in the seventh step, and a ninth step of searching for a document with use of the tag received in the eighth step.

In the above document search method, it is preferable that each of the plurality of pieces of document data be given at least one tag, that the search query include at least one tag, that a step of generating a feature vector for each of the plurality of pieces of document data with use of the tag given to the document data be included between the first step and the third step, that a step of vectorizing the search query with use of the tag included in the search query be further included between the second step and the third step, and that in the third step, a similarity between the feature vector and the vectorized search query be calculated for each of the plurality of pieces of document data.

In the above document search method, it is preferable that in the sixth step, learning of a classifier be performed with use of the classification and the feature vector as learning data to calculate the importance of each of the plurality of tags from the classifier.

In the above document search method, it is preferable that the search query include at least one word, that a step of generating a first feature vector for each of the plurality of pieces of document data with use of a word extracted from the document data be included between the first step and the third step, that a step of vectorizing the search query with use of the word included in the search query be further included between the second step and the third step, and that in the third step, a similarity between the first feature vector and the vectorized search query be calculated for each of the plurality of pieces of document data.

In the above document search method, it is preferable that each of the plurality of pieces of document data be given at least one tag, that in the sixth step, learning of a classifier be performed with use of the classification and a second feature vector as learning data to calculate the importance of each of the plurality of tags from the classifier, and that the second feature vector of the document data be generated with use of the tag given to the document data.

In the above document search method, it is preferable that in the inference performed in the sixth step, a probability of determining the document data be calculated, and that in the seventh step, the probability of determining the document data be output.

Another embodiment of the present invention is a document search method including a first step of receiving a plurality of pieces of document data, a second step of receiving a search query, a third step of evaluating each of the plurality of pieces of document data on the basis of the search query, a fourth step of outputting an evaluation result of at least a part of the plurality of pieces of document data, a fifth step of receiving classification of at least the part of the plurality of pieces of document data, a sixth step of inferring importance of each of a plurality of words from the classification, a seventh step of outputting the importance of at least a part of the plurality of words, an eighth step of receiving at least one of the words whose importance is output in the seventh step, and a ninth step of searching for a document with use of the word received in the eighth step.

In the above document search method, it is preferable that the search query include at least one word, that a step of extracting a word from each of the plurality of pieces of document data be included between the first step and a third step, and that in the third step, a similarity between the word extracted in the above step and a word included in the search query be calculated for each of the plurality of pieces of document data.

In the above document search method, it is preferable that in the sixth step, learning of a classifier be performed with use of the classification and the word extracted in the above step as learning data to calculate the importance of each of the plurality of words from the classifier.

In the above document search method, it is preferable that each of the plurality of pieces of document data be given at least one tag, that the search query include at least one tag, that a step of generating a first feature vector for each of the plurality of pieces of document data with use of the tag given to the document data be included between the first step and the third step, that a step of vectorizing the search query with use of the tag included in the search query be further included between the second step and the third step, and that in the third step, a similarity between the first feature vector and the vectorized search query be calculated for each of the plurality of pieces of document data.

In the above document search method, it is preferable that in the sixth step, learning of a classifier be performed with use of the classification and a second feature vector as learning data to calculate the importance of each of the plurality of words from the classifier, and that the second feature vector of the document data be generated with use of a word extracted from the document data.

In the above document search method, it is preferable that in the inference performed in the sixth step, a probability of determining the document data be calculated, and that in the seventh step, the probability of determining the document data be output.

Another embodiment of the present invention is a document search system including a reception unit, a processing unit, and an output unit; the reception unit has a function of receiving a search query, document data, classification and a tag; the processing unit has a function of evaluating the document data on the basis of the search query and a function of inferring importance of the tag from the classification; and the output unit has a function of outputting an evaluation result of the document data and a function of outputting the importance of the tag.

In the above document search system, it is preferable that the document data be given at least one tag, that the document data has a feature vector generated with use of the tag given to the document data, and that the processing unit have a function of vectorizing the search query and a function of calculating a similarity between the vectorized search query and the feature vector.

In the above document search system, it is preferable that a storage unit be further included, that a classifier be stored in the storage unit, and that the processing unit have a function of performing learning of the classifier with use of the classification and the feature vector as learning data and a function of calculating the importance of the tag from the classifier.

### Effect of the Invention

According to one embodiment of the present invention, a document search system, a document search method, or a method for outputting a document search result, which is of intuitive and efficient for a user, can be provided. According to another embodiment of the present invention, a document search system, a document search method, or a method for outputting a document search result, which can be operated easily by a user, can be provided. According to another embodiment of the present invention, a document search system, a document search method, or a method for outputting a document search result, which enables a user to obtain needed information efficiently, can be provided.

Note that the description of these effects does not preclude the existence of other effects. One embodiment of the present invention does not necessarily have all of these effects. Other effects can be derived from the description of the specification, the drawings, and the claims.

### BRIEF DESCRIPTION OF THE DRAWINGS

FIG. 1 is a diagram illustrating an example of a document search system.

FIG. 2 is a diagram illustrating an example of a document search method.

FIG. 3A to FIG. 3D are diagrams showing an example of a document search method.

FIG. 4A and FIG. 4B are diagrams each showing an example of a document search method.

FIG. 5 is a diagram showing an example of a document search method.

FIG. 6A and FIG. 6B are diagrams showing an example of a document search method.

FIG. 7 is a diagram showing an example of a document search method.

FIG. 8 is a diagram showing an example of a document search method.

FIG. 9 is a diagram showing an example of a document search method.

FIG. 10A and FIG. 10B are diagrams showing an example of a document search method.

FIG. 11 illustrates an example of a graphical user interface.

FIG. 12 illustrates an example of a graphical user interface.

FIG. 13 illustrates an example of a graphical user interface.

FIG. 14 illustrates an example of a graphical user interface.

FIG. 15 is a diagram illustrating an example of a document search system.

FIG. 16 is a diagram illustrating an example of a document search system.

### MODE FOR CARRYING OUT THE INVENTION

Embodiments will be described in detail with reference to the drawings. Note that the present invention is not limited to the following description, and it will be readily appreciated by those skilled in the art that modes and details of the present invention can be modified in various ways without departing from the spirit and scope of the present invention. Therefore, the present invention should not be construed as being limited to the description in the following embodiments.

Note that in structures of the invention described below, the same portions or portions having similar functions are denoted by the same reference numerals in different drawings, and the description thereof is not repeated. The same hatching pattern is used for portions having similar functions, and the portions are not especially denoted by reference numerals in some cases.

Note that ordinal numbers such as “first”, “second”, and “third” used in this specification and the like are used in order to avoid confusion among components, and the terms do not limit the components numerically. For example, the first row is not limited to the first row and the first column is not limited to the first column.

The position, size, range, or the like of each component illustrated in drawings does not represent the actual position, size, range, or the like in some cases for easy understanding. Therefore, the disclosed invention is not necessarily limited to the position, size, range, or the like disclosed in the drawings.

In this specification and the like, when a plurality of components are denoted with the same reference numerals, and in particular need to be distinguished from each other, an identification sign such as “_1”, “[n]”, or “[m,n]” is sometimes added to the reference numerals.

In this specification and the like, a document means a description of a phenomenon in natural language, which includes one or more sentences and is computerized and machine-readable, unless otherwise described. Examples of a document include patent application documents, books, magazines, newspapers, academic papers, decision documents, contracts, terms and conditions, regulations, product manuals, novels, publications, white papers, technical documents, and business documents, but are not limited thereto. In this specification and the like, a patent application document is referred to as a patent document in some cases.

In this specification and the like, a search query is a concept a user wants to search for, which is expressed in some form. Here, the search query refers to various search conditions to be input by a user making a search. There is no particular limitation on the search conditions, and examples of the search conditions include one or more words, one or more phrases, and one or more sentences. Alternatively, examples of the search conditions include a search formula constructed by a logical operator and at least one kind of one or more words, one or more phrases, and one or more sentences. The logical operator is also referred to as a Boolean operator, and examples include, but not limited to, AND, OR, and NOT. When these logical operators are used, the search formula is an AND search, an OR search, an NOT search, or the like. Alternatively, a natural sentence may be received as the search query, and a word extracted by language processing may be used as a search keyword or a sentence vector may be generated using distributed representation.

In this specification and the like, the collection of data that is configured with a model of columns and rows (vertical axis and horizontal axis) is referred to a table or a table format. Thus, the collection of data can be referred to as a table or a table format when it is configured with a model of columns and rows (vertical axis and horizontal axis) regardless of the presence or absence of ruled lines.

### Embodiment 1

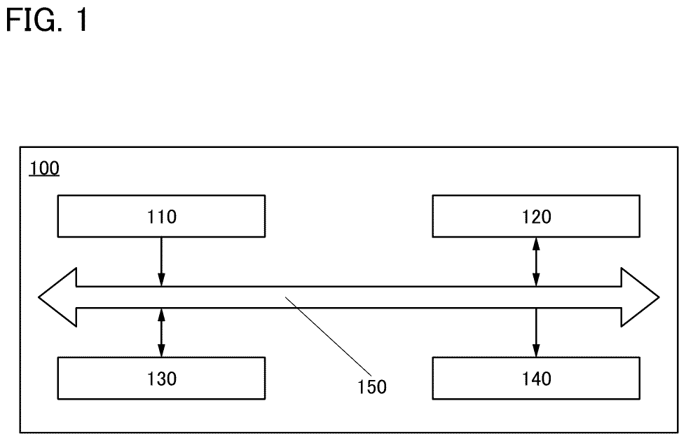

In this embodiment, a document search system, a document search method, a method for outputting a document search result, and a method for displaying a document search result, which are embodiments of the present invention, will be described with reference to FIG. 1 to FIG. 14.

In a document search system of one embodiment of the present invention, for example, a search for a document to which a tag is given is performed. For example, in the document search system, a set of document data is created, the importance of the tag is calculated from the classification of the set of document data, and document search is performed with use of the tag. The set of document data is created on the basis of a search query. The set of document data is created on the basis of a result of evaluation performed on the basis of the search query.

A user of the document search system inputs the above search query, performs the classification, and selects a tag used for the document search. When the user carries out the document search in an interactive mode, the search that is of intuitive and efficient for the user becomes possible.

Specifically, in the document search system, first, a plurality of pieces of document data are received. Next, a search query is received. Next, each of the plurality of pieces of document data is evaluated on the basis of the search query. Examples of the evaluation include the calculation of a similarity between the search query and document data. Then, an evaluation result of at least part of the plurality of pieces of document data is output. Note that at least the part of the plurality of pieces of document data corresponds to the above-described set of document data.

As the output, for example, the evaluation result can be displayed on a display screen (simply referred to as a screen in some cases, in this specification and the like) of a terminal used by the user. Note that there is no particular limitation on the display screen as long as it belongs to display devices, and may be a multidisplay described later, for example.

The user of the document search system classifies at least part of the plurality of pieces of document data. The user can classify document data with reference to the output evaluation result.

Next, in the above document search system, the classification is received. Next, the importance of tags is inferred from the received classification. Then, the importance of tags is output.

The user selects at least one of the tags whose importance is output. The user can select any of the tags while referring to the importance of the output tags.

Next, in the document search system, the selected tag is received. Next, a search for a document is performed with use of the received tag.

As described above, the document search system of one embodiment of the present invention can designate a tag preferably used for a search query in the document search. Thus, the user can be easily made aware of a tag preferably used for a search query in the document search and thus can search for a document efficiently.

As another example of the document search system of one embodiment of the present invention, a document to which a tag is not given can be performed. For example, in the document search system, a set of document data is created, the importance of a word is calculated from the classification of the set of document data, and a search for a document is performed with use of the word. The set of document data is created on the basis of a search query.

The user of the document search system inputs the search query, performs the classification, and selects a word used for the document search. When the user carries out the document search in an interactive mode, the search that is of intuitive and efficient for the user becomes possible.

Note that in the above document search system, the steps up to the reception of the classification from the reception of the plurality of pieces of document data are similar to those in the above document search system.

Next, in the document search system, the importance of words is inferred from the received classification. Then, the importance of words is output.

The user selects at least one of the words whose importance is output. The user can select any of the words while referring to the importance of the output words.

Next, in the document search system, the selected word is received. Next, a search for a document is performed with use of the received word.

As described above, the document search system of one embodiment of the present invention can designate a word preferably used for a search query in the document search. Thus, the user can be easily made aware of a word preferably used for a search query in the document search and thus can search for a document efficiently.

Note that usage application of the document search system in this embodiment is not particularly limited, and the usage application examples can include a survey of patent documents.

### Document Search System 1

FIG. 1 shows a block diagram of a document search system 100. The document search system 100 includes a reception unit 110, a storage unit 120, a processing unit 130, an output unit 140, and a transmission path 150.

The document search system 100 may be provided in a data processing device such as a personal computer used by a user. Alternatively, a processing unit of the document search system 100 may be provided in a server to be accessed by a client PC via a network and used.

### Reception Unit 110

The reception unit 110 receives document data. The number of pieces of document data received by the reception unit 110 may be one or two or more.

There is no particular limitation on the document data received by the reception unit 110, and various kinds of document data can be received. The document data is a computerized and machine-readable document. Examples of the document include patent application documents, books, magazines, newspaper, academic papers, decision documents, contracts, terms and conditions, regulations, product manuals, novels, publications, white papers, technical documents, and business documents. The patent application document includes at least one of a specification, a scope of claims, and an abstract.

Furthermore, information on the document data (also referred to as related information on document data) is given to the document data. For example, when the document is a patent application document (patent document), examples of information on the document data include an application management number (including a certain number assigned by a user), an application family management number, an application number, a publication number, a registration number, a drawing, an application date, a priority date, a publication date, a status, classification (e.g., patent classification or utility model classification), category, and a keyword (including a certain word of phrase assigned by the user). With use of one or more of these pieces of information, document data can be specified. Thus, these pieces of information can be used as items for identifying the document data. Alternatively, these pieces of information may be output together with an evaluation result described later.

Examples of the patent classification include CPC, IPC, FI, and F-terms. The patent classification is composed of a plurality of classification codes. Like the patent classification, information given in accordance with the contents of a document is collectively referred to as classification in this specification and the like. In addition, individual information given in accordance with the contents of the document is referred to as a tag. Examples of the tag include a code composed of marks such as alphanumeric symbols and a keyword (including a certain word or phrase assigned by the user).

Furthermore, for example, when the document is a book, a magazine, newspaper, an academic paper, a decision document, a contract, terms and conditions, regulations, a product manual, a novel, a publication, a white paper, a technical document, a business document, or the like, examples of information on the document data include the number for identifying the document, a title, the date of publication or the like, an author name, and a publisher name. With use of one or more of these pieces of information, document data can be specified. Thus, these pieces of information can be used as items for identifying the document data. Alternatively, these pieces of information may each be output together with an evaluation result described later.

The document data received by the reception unit 110 is preferably given the classification. For example, at least one tag is preferably given to the document data. In that case, the reception unit 110 preferably has a function of receiving a tag. Note that the classification given to the document data is referred to as first classification in some cases.

The tag given to the document data received by the reception unit 110 may be either a code or a keyword. The keyword may be a word or phrase included in the document data or a word or phrase not included in the document data, for example. As a word or phrase that is not included in the document data, any word or phrase assigned by the user may be used.

Note that the document data received by the reception unit 110 is not necessarily given the classification. In that case, the reception unit 110 preferably has a function of receiving a word.

The document data received by the reception unit 110 may include a feature vector. The number of feature vectors of the document data may be one, two, or three or more.

The feature vector of the document data is preferably generated using at least one of pieces of information on the document data. For example, in the case where at least one tag is given to the document data, the feature vector of the document data is preferably generated using the tag given to the document data. The feature vector of the document data is preferably generated using a word extracted from the document data.

Note that the document data received by the reception unit 110 does not necessarily include a feature vector.

The reception unit 110 receives a search query. The number of search queries received by the reception unit 110 may be one or two or more.

The search query received by the reception unit 110 is one or more words, one or more phrases, one or more sentences, or a combination thereof. Alternatively, one or more tags are included.

The reception unit 110 receives classification. The classification received by the reception unit 110 is referred to as second classification in some cases.

The reception unit 110 has a function of transmitting and receiving data. At this time, the reception unit 110 can be rephrased as a communication unit. Examples of the communication unit include a hub, a router, and a modem. The reception unit 110 may have a function of receiving a user's input operation. In this case, the reception unit 110 can be rephrased as an input unit. Examples of the input unit include a mouse, a keyboard, a touch panel, a microphone, a scanner, and a camera.

Data such as the search query and the document data supplied to the reception unit 110 is supplied to one or both of the storage unit 120 and the processing unit 130 through the transmission path 150.

### Storage Unit 120

The storage unit 120 has a function of storing a program executed by the processing unit 130. The storage unit 120 may have a function of storing data (e.g., a calculation result and an inference result) generated by the processing unit 130, data input to the reception unit 110, and the like.

A classifier is preferably stored in the storage unit 120. Examples of the classifier include a neural network, a decision tree, Lasso regression, and random forest. The classifier is used for learning and inference performed in the processing unit 130. The classifier may be used for the evaluation performed in the processing unit 130.

The storage unit 120 includes at least one of a volatile memory and a nonvolatile memory. As the volatile memory, a DRAM (Dynamic Random Access Memory), an SRAM (Static Random Access Memory), and the like can be given. Examples of the nonvolatile memory include an ReRAM (Resistive Random Access Memory, also referred to as a resistance-change memory), a PRAM (Phase change Random Access Memory), an FeRAM (Ferroelectric Random Access Memory), an MRAM (Magnetoresistive Random Access Memory, also referred to as a magneto-resistive memory), and a flash memory. The storage unit 120 may include a storage media drive. As the storage media drive, a hard disk drive (HDD), a solid state drive (SSD), or the like can be given.

The storage unit 120 may include a database containing document data.

The document search system 100 may have a function of extracting (reading) document data (specifically, data needed for subsequent processing) from a database existing outside the system. For example, the document search system 100 may have a function of extracting data from a database existing outside the system.

Alternatively, the document search system 100 may have a function of extracting data from both of its own database and an external database.

The database can have a structure containing either or both of text data and image data, for example.

One or both of a storage and a file server may be used instead of the database. For example, in the case where a file contained in a file server is used, the database preferably contains a path for the file stored in the file server.

An application database can be given as an example of the database. Examples of the application include applications relating to intellectual properties, such as a patent application, an application for utility model registration, and an application for design registration. There is no limitation on each status of the applications, i.e., whether or not it is published, whether or not it is pending in the Patent Office, and whether or not it is registered. For example, the application database can contain at least one of applications before examination, applications under examination, and registered applications, or may contain all of them.

For example, the application database preferably contains at least one of a specification, an abstract, and a scope of claims in each of a plurality of patent applications. The specifications, abstracts, and scopes of claims are stored in text data, for example.

In addition, various kinds of documents such as a book, a magazine, newspaper, an academic paper, a decision document, a contract, terms and conditions, regulations, a product manual, a novel, a publication, a white paper, a technical document, and a business document can be managed in the database. The database contains at least document data.

### Processing Unit 130

The processing unit 130 has a function of performing processing such as arithmetic operation and inference with use of data supplied from one or both of the reception unit 110 and the storage unit 120. The processing unit 130 can supply generated data (e.g., an arithmetic operation result or an inference result) to one or both of the storage unit 120 and the output unit 140.

The processing unit 130 has a function of evaluating document data on the basis of a search query. For example, the processing unit 130 has a function of evaluating the document data supplied to the reception unit 110 on the basis of the search query supplied to the reception unit 110.

The processing unit 130 preferably has a function of vectorizing the search query supplied to the reception unit 110. Furthermore, the processing unit 130 preferably has a function of calculating a similarity between the vectorized search query and a feature vector of the document data. Thus, in the case where the document data supplied to the reception unit 110 has a feature vector, the similarity between the vectorized search query and the feature vector is calculated, so that the document data can be evaluated.

The processing unit 130 preferably has a function of generating a feature vector of the document data with use of at least one piece of information on the document data. For example, in the case where at least one tag is given to the document data, the processing unit 130 preferably has a function of generating a feature vector with use of the tag given to the document data. Furthermore, the processing unit 130 preferably has a function of generating a feature vector with use of a word extracted from the document data. Thus, in the case where the document data supplied to the reception unit 110 does not have a feature vector, using at least one piece of information on the document data allows generation of a feature vector of the document data. The generation of a feature vector enables evaluation to be performed on the document data.

The processing unit 130 preferably has a function of extracting a word related to the document data. For example, the processing unit 130 preferably has a function of performing one or both of morphological analysis and compound word analysis. Thus, a word can be extracted from one or more sentences included in the document data. Furthermore, a word can be extracted from at least one or more sentences included in information related to the document data.

Note that in this specification and the like, a word related to document data refers to, in some cases, a word extracted from one or more sentences included in the document data or a word extracted from one or more sentences included in at least one piece of information related to the document data.

The processing unit 130 has a function of inferring the importance of a tag from the second classification. For example, the processing unit 130 has a function of inferring the importance of a tag included in the document data supplied to the reception unit 110, from the second classification supplied to the reception unit 110. Specifically, the processing unit 130 has a function of performing learning of the classifier supplied from the storage unit 120 with use of the feature vector and the second classification supplied to the reception unit 110 as learning data and a function of calculating the importance of a tag from the classifier. Note that the feature vector corresponds to the feature vector of the document data or the feature vector generated using information on the document data in the processing unit 130.

The processing unit 130 may have a function of inferring the importance of a word from the second classification. For example, the processing unit 130 has a function of inferring the importance of a word included in the document data supplied to the reception unit 110 from the second classification supplied to the reception unit 110. Specifically, the processing unit 130 has a function of performing learning of a classifier supplied from the storage unit 120 with use of the feature vector and the second classification supplied to the reception unit 110 as learning data and a function of calculating the importance of a word from the classifier. Note that the word whose importance is calculated corresponds to the word included in the document data or the word extracted from the document data by the processing unit 130.

The processing unit 130 may have a function of inferring the probability of determining the document data from the second classification. For example, the processing unit 130 has a function of inferring the probability of determining the document data supplied to the reception unit 110 from the second classification supplied to the reception unit 110. Specifically, the processing unit 130 has a function of performing learning of the classifier supplied from the storage unit 120 with use of the second classification and the feature vector supplied to the reception unit 110 as learning data, and a function of calculating a probability of determining the document data from the classifier.

Note that a feature vector used in calculation of a similarity (also referred to as a first feature vector) is, depending on the situation, the same as or different from a feature vector used in learning of a classifier (also referred to as a second feature vector). Detailed description will be made later.

The processing unit 130 has a search function. In particular, the processing unit 130 preferably has a search function using a search formula generated by a combination of a logical operator with a tag, a word, or a phrase.

The processing unit 130 can include an arithmetic circuit, for example. The processing unit 130 can include, for example, a central processing unit (CPU).

The processing unit 130 may include a microprocessor such as a DSP (Digital Signal Processor) or a GPU (Graphics Processing Unit). The microprocessor may be constructed with a PLD (Programmable Logic Device) such as an FPGA (Field Programmable Gate Array) or an FPAA (Field Programmable Analog Array). The processing unit 130 can interpret and execute instructions from various programs with use of a processor to process various kinds of data and control programs. The programs to be executed by the processor are stored in at least one of a memory region of the processor or the storage unit 120.

The processing unit 130 may include a main memory. The main memory includes at least one of a volatile memory such as a RAM (Random Access Memory) and a nonvolatile memory such as a ROM (Read Only Memory).

For example, a DRAM, an SRAM, or the like is used as the RAM, a virtual memory space is assigned in the RAM and utilized as a working space of the processing unit 130. An operating system, an application program, a program module, program data, a look-up table, and the like that are stored in the storage unit 120 are loaded into the RAM for execution. The data, program, and program module that are loaded into the RAM are each directly accessed and operated by the processing unit 130.

In the ROM, a BIOS (Basic Input/Output System), firmware, and the like for which rewriting is not needed can be stored. Examples of the ROM include a mask ROM, an OTPROM (One Time Programmable Read Only Memory), and an EPROM (Erasable Programmable Read Only Memory). Examples of the EPROM include a UV-EPROM (Ultra-Violet Erasable Programmable Read Only Memory) which can erase stored data by ultraviolet irradiation, an EEPROM (Electrically Erasable Programmable Read Only Memory), and a flash memory.

It is preferable to use artificial intelligence (AI) for at least part of processing of the document search system.

It is particularly preferable to use an artificial neural network (ANN; hereinafter just referred to as neural network) for the document search system. The neural network is obtained with a circuit (hardware) or a program (software).

In this specification and the like, a neural network refers to a general model that is modeled on a biological neural network, determines the connection strength of neurons by learning, and has the capability of solving problems. A neural network includes an input layer, intermediate layers (hidden layers), and an output layer.

In the description of the neural network in this specification and the like, to determine a connection strength of neurons (also referred to as a weight coefficient) from the existing information is referred to as “learning” in some cases.

In this specification and the like, to draw a new conclusion from a neural network formed with the connection strength obtained by learning is referred to as “inference” in some cases.

### Output Unit 140

The output unit 140 outputs information on the basis of the processing result in the processing unit 130. For example, data generated by the processing unit 130 (e.g., an arithmetic result or an inference result) can be supplied to the outside of the document search system 100. The output unit 140 can output information to a terminal, a display, or the like used by the user.

The output unit 140 has a function of outputting an evaluation result of the document data. Furthermore, the output unit 140 has a function of outputting an evaluation result of the document data together with information on the document data. For example, the output unit 140 outputs an evaluation result of the document data obtained in the processing unit 130 in a table format, together with information on the document data. Note that the evaluation result output by the output unit 140 is not limited to the table format and may be a tree format (tree structure), for example.

The output unit 140 has a function of outputting the importance of a tag. Furthermore, the output unit 140 has a function of outputting the importance of a tag together with the tag. In other words, the output unit 140 has a function of outputting a tag and the importance of the tag. For example, the output unit 140 outputs, together with a tag, the importance of the tag calculated in the processing unit 130 in a table format. Note that the result output by the output unit 140 is not limited to the table format and may be a tree format (tree structure), for example.

The output unit 140 has a function of outputting a probability of determining the document data. In addition, the output unit 140 has a function of outputting a probability of determining the document data together with information on the document data. In other words, the output unit 140 has a function of outputting information on the document data and a probability of determining the document data. For example, the output unit 140 outputs, together with information on the document data, a probability of determining the document data calculated in the processing unit 130 in a table format. Note that the result output by the output unit 140 is not limited to the table format and may be a tree format (tree structure), for example.

The output unit 140 preferably has a function of transmitting and receiving data. In that case, the output unit 140 can be referred to as a communication unit. Examples of the communication unit include a hub, a router, and a modem. The output unit 140 may have a function of displaying a processing result. In that case, the output unit 140 can be referred to as a display unit. Examples of the display unit includes display devices such as a liquid crystal display device and a light-emitting display device. The number of display devices used as the display unit is not limited. The number of display devices used as the display unit may be one or two or more. A display unit where a plurality of display devices are arranged is referred to as a multimonitor or multidisplay in some cases.

### Transmission Path 150

The transmission path has a function of transmitting data. Data transmission and reception among the reception unit 110, the storage unit 120, the processing unit 130, and the output unit 140 can be performed through the transmission path 150.

Although the functions included in the document search system 100 are classified and independent from each other in FIG. 1, part or all of the functions included in the document search system 100 are not necessarily independent. For example, the processing unit 130 may have one or both of functions of the reception unit 110 and the output unit 140. In other words, the processing unit 130 may serve as one or both of the reception unit 110 and the output unit 140.

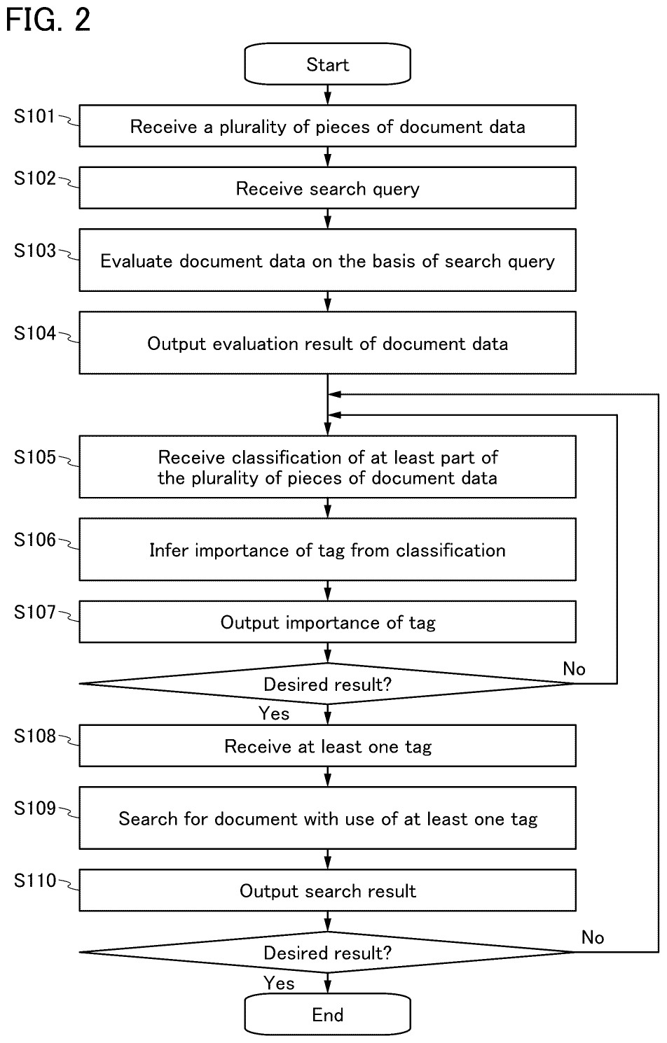

A document search method and a method for outputting a document search result of the document search system of one embodiment of the present invention are described with reference to FIG. 2 to FIG. 14. Note that a display method using a display is given below as an example of the output method. That is, the method for displaying a document search result of one embodiment of the present invention is described below.

### Document Search Method 1

In <Document search method 1> of this embodiment, a document search method where a search for a document is performed with use of a tag is described. <Document search method 1> of this embodiment is effective in searching for a document to which classification (the above-described first classification) is given.

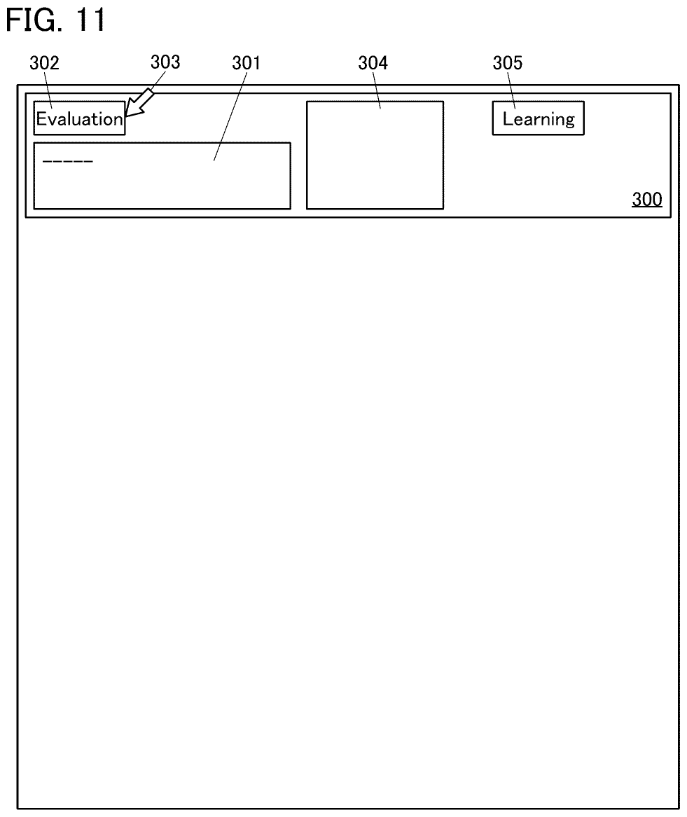

FIG. 11 to FIG. 14 each illustrate an example of a graphical user interface (GUI) of the document search system of this embodiment. Icons, windows, buttons, text boxes, and the like and the placement thereof in FIG. 11 to FIG. 14 are examples and there are no particularly limitations thereon. A GUI can be constructed as a web page accessed by a user via a network. Alternatively, a GUI can be constructed as a screen of a program application executed on an information processing device such as a personal computer used by the user.

### Document Search Method 1a

A document search method 1a of this embodiment shows an example of <Document search method 1> of this embodiment. Note that in the document search method la of this embodiment, a search query includes at least one tag. The tag may be a code or a keyword.

The document search method la of this embodiment includes processing composed of Step S101 to Step S110 illustrated in FIG. 2.

### Step S101

In Step S101, a plurality of pieces of document data are received. Each of the plurality of pieces of document data includes text data. Furthermore, each of the plurality of pieces of document data may include data other than text data (e.g., image data). In <Document search method 1> of this embodiment, m (m is an integer greater than or equal to 1) pieces of document data are received. Hereinafter, m pieces of document data received in Step S101 are referred to as first document data to m-th document data. The plurality of pieces of document data (the first document data to the m-th document data) received in Step S101 are collectively referred to as a document data group.

Note that steps after Step S102 are mainly performed with use of text data.

It is preferable to give classification (also referred to as the first classification) to each of the plurality of pieces of document data received in Step S101. In particular, it is preferable to give at least one tag to each of the plurality of pieces of document data. Note that a plurality of kinds of tags exist. Hereinafter, a set including all tags prepared in advance is referred to as a first tag group.

In the document search method 1a of this embodiment, an i-th (i is an integer greater than or equal to 1 and less than or equal to m) document data is given n[i] (n[i] is an integer greater than or equal to 1) tags. Hereinafter, in the case where the document data group is composed of document data to which the first classification is given, the set (sum of sets) including all tags given to the document data group is referred to as a second tag group. That is, the second tag group is also a subset of the first tag group.

### Step S102

In Step S102, a search query is received. In the document search method 1a of this embodiment, at least one tag is received as a search query.

A region 300 in FIG. 11 to FIG. 14 is a region that the user can use to input a search query. In FIG. 11 to FIG. 14, a region 301 where a search query is input is displayed on the region 300. The user inputs a search query to the region 301. Note that in the case where a plurality of words, a plurality of phrases, a combination of a word and a phrase, or the like is input to the region 301, a delimiter is preferably provided between the words, between the phrases, or between the word and the phrase. Examples of the delimiter include line breaks, tabs, semicolons, slashes, and back slashes. Alternatively, a word, a phrase, or a sentence included in a region sandwiched between single quotes, double quotes, or parentheses can be regarded as one search query. The same applies to the case where a plurality of tags are input to the region 301.

Each of the plurality of pieces of document data preferably has a first feature vector. Note that in the case where the search query includes a tag, the first feature vector of the document data is preferably generated using the tag given to the document data. For example, the first feature vector of the i-th document data is preferably generated using n[i] tags given to the i-th document data.

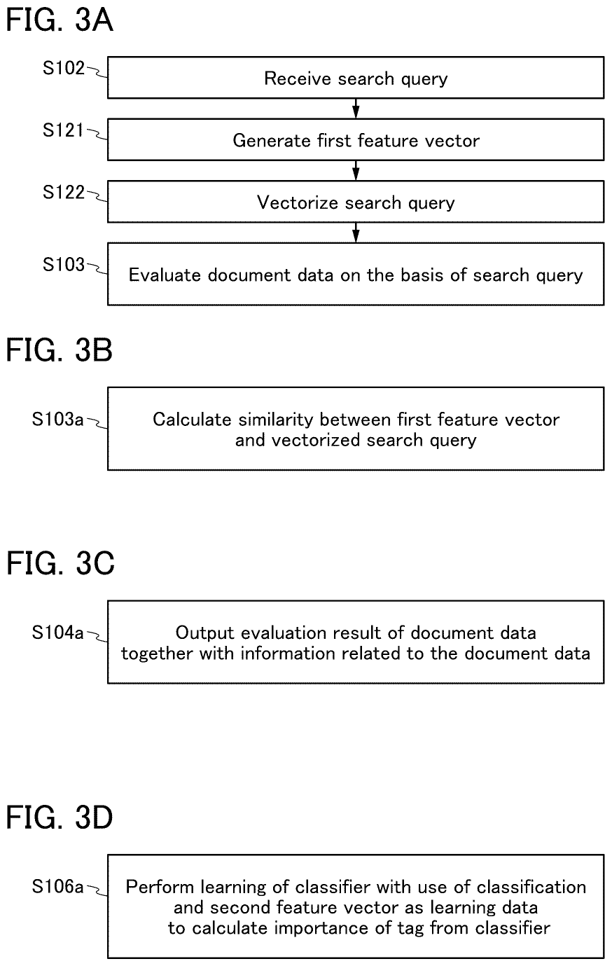

Note that each of the plurality of pieces of document data does not necessarily have the first feature vector. In that case, as illustrated in FIG. 3A, processing of Step S121 is preferably included between the processing of Step S101 and the processing of Step S103. In Step S121, a first feature vector is generated for each of the plurality of pieces of document data received in Step S101. The first feature vector of the document data is preferably generated using the tag given to the document data. For example, in Step S121, a first feature vector of the i-th document data is generated using n[i] tags given to the i-th document data. This processing is preferably performed on each of the m pieces of document data.

In the document search method 1a of this embodiment, the first feature vector of the document data can be used as a second feature vector described in [Step S106] described later.

In addition, processing of Step S122 is preferably included between the processing of Step S102 and the processing of Step S103, as illustrated in FIG. 3A. In Step S122, the search query received in Step S102 is vectorized. In the document search method 1a of this embodiment, the search query is vectorized using the tag included in the search query.

Although FIG. 3A illustrates an example where the processing of Step S122 is performed after the processing of Step S121, the present invention is not limited thereto. The processing of Step S122 may be performed before the processing of Step S121, or the processing of Step S121 and the processing of Step S122 may be performed in parallel.

### Step S103

In Step S103, evaluation of document data is performed on the basis of the search query. The document data to be evaluated is the plurality of pieces of document data received in Step S101. For example, in Step S103, each of the m pieces of document data is evaluated on the basis of the search query.

As Step S103, processing of Step S103a illustrated in FIG. 3B is preferably performed. The processing of Step S103a is to calculate a similarity between the first feature vector and the vectorized search query for each of the plurality of pieces of document data received in Step S101. Note that in Step S103a, the distance between the first feature vector and the vectorized search query may be calculated for each of the plurality of pieces of document data received in Step S101. For example, in Step S103, the similarity or the distance between the first feature vector of the i-th document data and the vectorized search query is calculated. This processing is preferably performed on each of the m pieces of document data.

The similarity between two vectors can be calculated using cosine similarity, the covariance, the unbiased covariance, the Pearson product-moment correlation coefficient, or the like. Among them, cosine similarity is particularly preferably used.

The distance between two vectors may be calculated using Euclidean distance, standard (standardized, average) Euclidean distance, Mahalanobis distance, Manhattan distance, Chebyshev distance, Minkowski distance, or the like.

As shown in FIG. 11, when the user selects an icon 302 marked “Search” with a mouse pointer 303 after inputting the search query in the region 301, the document search system receives the search query and starts the evaluation of the document data based on the search query. That is, the processing of Step S102 and Step S103 is performed. Note that Step S121, Step S122, and the like are also performed depending on the document data received in Step S101 and the search query received in Step S102.

### Step S104

In Step S104, an evaluation result of the document data is output. Note that the document data whose evaluation result is output is at least one of the plurality of pieces of document data received in Step S101. That is, the document data whose evaluation result is output may be part of the plurality of pieces of document data received in Step S101 or all the pieces of document data received in Step S101. For example, the document data whose evaluation result is output may be part of m pieces of document data or may be all the m pieces of document data.

Hereinafter, the document data whose evaluation result is output in Step S104 is referred to as evaluated document data in some cases. In <Document search method 1> of this embodiment, evaluation results of p (p is an integer greater than or equal to 1 and less than or equal to m) pieces of document data out of m pieces of document data are displayed in Step S104. That is, evaluation results of the p pieces of evaluated document data are displayed in Step S104. The p pieces of evaluated document data are referred to as first evaluated document data to p-th evaluated document data. The first evaluated document data to the p-th evaluated document data are collectively referred to as an evaluated document data group. That is, in Step S104, evaluation results of the evaluated document data group are each output. The evaluated document data group is also a subset of the document data group.

Note that the document search method la of this embodiment may include processing of Step S104a illustrated in FIG. 3C, instead of the processing of Step S104. In Step S104a, an evaluation result of the document data is output together with information related to the document data. The document data whose evaluation result is output is the above-described evaluated document data group.

The evaluation result of the document data is preferably output in a table format, for example. For example, the evaluation result can be shown in at least one column in the table. In addition, the evaluation result of the first document data can be shown in a first row of the table, and the evaluation result of the second document data can be shown in a second row. Note that in the case where the evaluation result is output in a table format, the evaluation result may be output together with information on the document data.

The evaluation result of the document data, the importance of the tag, or the like may be output as a file in a CSV format or the like.

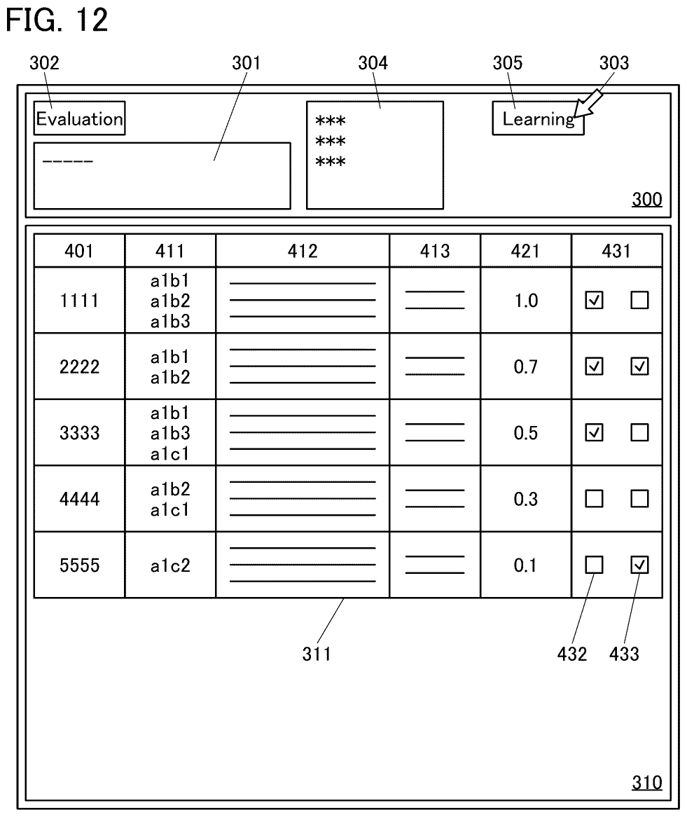

A region 310 illustrated in FIG. 12 to FIG. 14 is a region where related information and evaluation results of document data are displayed. Note that various kinds of data included in the database or the like may be displayed on the region 310. In FIG. 12, a table 311 showing an evaluation result is displayed in the region 310.

FIG. 12 is an example showing evaluation results of document data. In the table 311 in FIG. 12, items on the vertical axis indicate information specifying document data, and items on the horizontal axis indicate information related to the document data, evaluation 421, and classification 431 as examples. Note that information specifying document data is also information related to the document data.

A document ID 401 in the table 311 in FIG. 12 represents information specifying document data. In the case where the document data is a patent document, examples of the document ID 401 include an application number, a publication number, and a registration number.

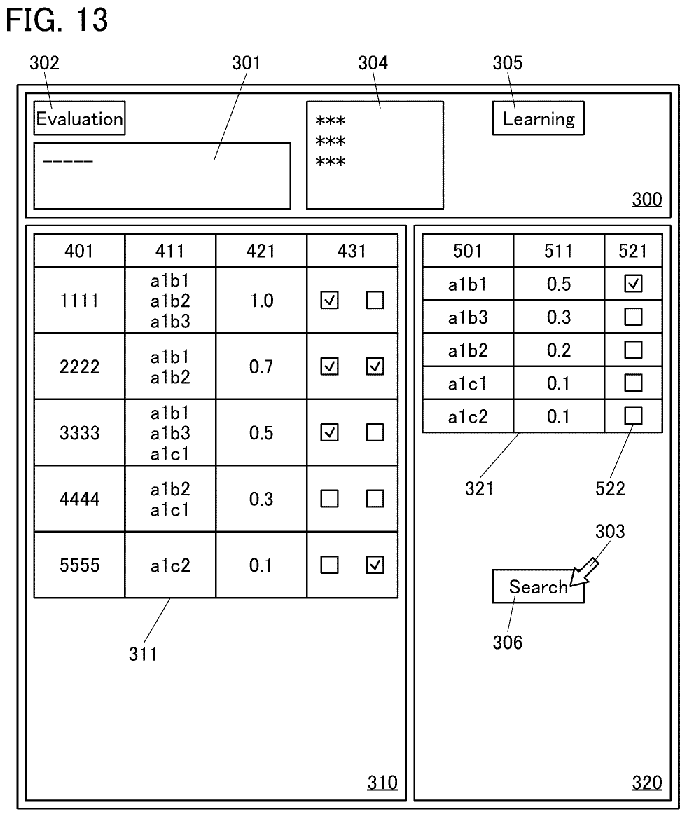

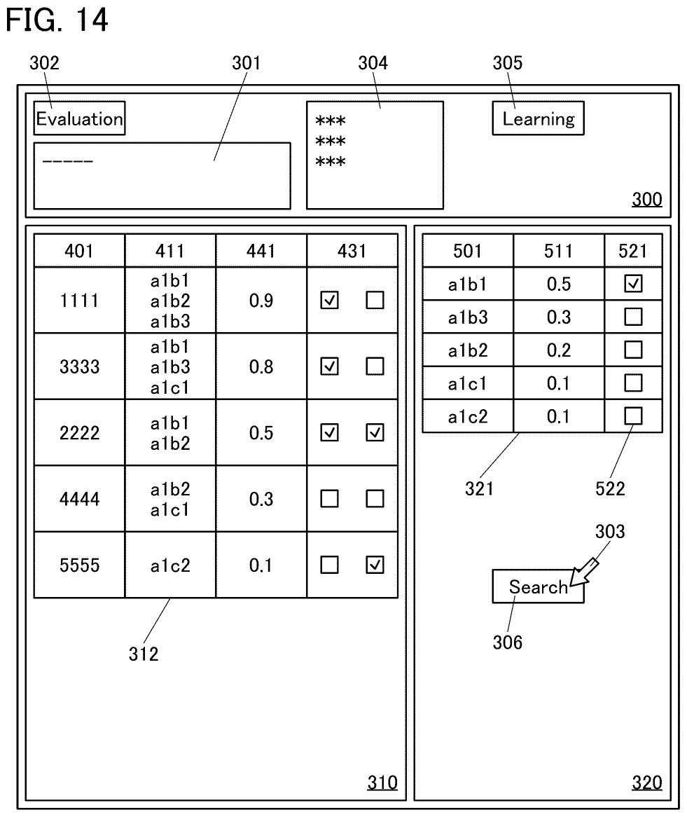

In each of the table 311 in FIG. 12 and FIG. 13 and a table 312 in FIG. 14, evaluation results of five pieces of document data are shown as an example. That is, p=5 in each of the table 311 in FIG. 12 and FIG. 13 and the table 312 in FIG. 14. Here, the document data whose document ID 401 is “1111” is referred to as first evaluated document data, the document data whose document ID 401 is “2222” is referred to as second evaluated document data, the document data whose document ID 401 is “3333” is referred to as third evaluated document data, the document data whose document ID 401 is “4444” is referred to as fourth evaluated document data, and the document data whose document ID 401 is “5555” is referred to as fifth evaluated document data.

Moreover, classification 411, information 412, and information 413 in the table 311 in FIG. 12 represent information related to the document data. Here, the classification 411 refers to the first classification given to the document data. In the case where the document data is a patent document, examples of the classification 411 include CPC, IPC, FI, and an F-term. Examples of the information 412 and the information 413 include an abstract, a scope of claims, a representative claim, application date, priority date, publication date, categories, and a keyword.

In the document search method 1a of this embodiment, q[j] (q[j] is an integer greater than or equal to 1) tags are displayed in a row where information related to a j-th (j is an integer greater than or equal to 1 and less than or equal to p) evaluated document data is displayed. Hereinafter, a set (sum of sets) of all tags given to the evaluated document data group is referred to as a third tag group. That is, the third tag group is also a subset of the second tag group.

For example, in FIG. 12, the first evaluated document data is given “a1b1”, “a1b2”, and “a1b3” as the classification 411, the second evaluated document data is given “a1b1” and “a1b2” as the classification 411, the third evaluated document data is given “a1b1”, “a1b3”, and “a1c1” as the classification 411, the fourth evaluated document data is given “a1b2” and “a1c1” as the classification 411, and the fifth evaluated document data is given “a1c2” as the classification 411.

In FIG. 12, for example, at least any one of “a1b1”, “a1b2”, “a1b3”, “a1c1”, and “a1c2” is given to each of the first evaluated document data to the fifth evaluated document data. Here, “a1b1” is a first tag, “a1b2” is a second tag, “a1b3” is a third tag, “a1c1” is a fourth tag, and “a1c2” is a fifth tag. In this case, the third tag group includes the first tag to the fifth tag.

Note that the information related to the document data displayed on the table 311 in FIG. 12 is not limited to the above, and one kind, two kinds, or four or more kinds of information may be displayed. Alternatively, the information related to the document data is not necessarily displayed on the table 311 in FIG. 12.

The evaluation 421 shown in the table 311 in FIG. 12 is the evaluation result of the document data obtained in Step S103. For example, in the case where the processing of Step S103a is performed (where the similarity or the distance between the first feature vector and the vectorized search query is calculated), a value of the calculated similarity or a value of distance is preferably displayed in columns whose item on the horizontal axis denotes the evaluation 421.

The pieces of document data output and displayed to/on the table 311 are preferably arranged in descending order of evaluation values. In FIG. 12, the pieces of document data are displayed so that the higher evaluation value the evaluated document data has, the upper row in the table 311 the evaluated document data is positioned. FIG. 12 shows an example where the evaluation 421 of the first evaluated document data is 1.0, the evaluation 421 of the second evaluated document data is 0.7, the evaluation 421 of the third evaluated document data is 0.5, the evaluation 421 of the fourth evaluated document data is 0.3, and the evaluation 421 of the fifth evaluated document data is 0.1. That is, in FIG. 12, the first evaluated document data, the second evaluated document data, the third evaluated document data, the fourth evaluated document data, and the fifth evaluated document data are displayed in this order from the above.

Note that the order of displaying the pieces of document data output to the table 311 is not limited to the case of the descending order of evaluation values. For example, the pieces of document data arranged in numerical order of the document ID 401 may be displayed, the pieces of document data arranged in numerical order of the information 412 or the information 413 may be displayed, or the pieces of document data arranged in ascending order of evaluation values may be displayed.

In the table 311, a check box is preferably provided in columns whose item on the horizontal axis denotes the classification 431. One check box may be provided per column, or a plurality of check boxes may be provided per column. The table 311 in FIG. 12 is provided with a first check box 432 and a second check box 433 as a check box.

### Step S105

In Step S105, classification of at least part of the plurality of pieces of document data is received. Hereinafter, classification received in Step S105 is referred to as second classification in some cases. Here, the document subjected to the second classification is preferably evaluated document data. For example, document data to be given the second classification is p pieces of evaluated document data. The user can select the second classification of the evaluated document data with reference to the information 412, the information 413, the evaluation 421, and the like of the evaluated document data.

The second classification is to make a determination whether or not the document data is close to a desired document. The user determines whether or not the document data is close to a desired document with use of the columns representing the classification 431 that is one of items on the horizontal axis of the table 311 in FIG. 12. In other words, the user classifies all pieces of the evaluated document data. The classification 431 in the table 311 refers to the second classification.

In the table 311 in FIG. 12, the first check box 432 and the second check box 433 are provided in every row. In this step, the user checks off the first check box 432 in the row belonging to specific document data when determining that the specific document data is close to a desired document. Alternatively, the user checks off the second check box 433 in the row belonging to the specific document data when determining the specific document data is not close to (is distant from) the desired document.

In some cases, the user faces difficulties in determining whether or not the specific document data is close to the desired data. In that case, it is preferable to check off both the first check box 432 and the second check box 433 in the row belonging to the specific document data. Alternatively, it is preferable to check neither the first check box 432 nor the second check box 433 in the row belonging to the specific document data. With such a construction, the user's determination can be accurately reflected in learning described later.

Moreover, the second classification of the document data can be carried out in advance in accordance with the evaluation result. For example, when the evaluation 421 of the specific document data is higher than or equal to a certain value (e.g., 0.8), it is preferable to check off the first check box 432 and not to check off the second check box 433, in the row belonging to the specific document data. For example, when the evaluation 421 of the specific document data is lower than or equal to another value (e.g., 0.2), it is preferable to check off the second check box 433 and not to check off the first check box 432, in the row belonging to the specific document data. Accordingly, the workload of classification done by the user can be reduced. Alternatively, the user only needs to determine whether or not the classification carried out in advance is appropriate, in some cases. Also in this case, the workload done by the user can be reduced.

FIG. 12 shows the following examples: the first check box 432 is checked off and the second check box 433 is not checked for the first evaluated document data; both the first check box 432 and the second check box 433 are checked for the second evaluated document data; the first check box 432 is checked and the second check box 433 is not checked for the third evaluated document data; neither the first check box 432 nor the second check box 433 is checked for the fourth evaluated document data; and the first check box 432 is not checked and the second check box 433 is checked for the fifth evaluated document data.

According to FIG. 12, it is found that the first evaluated document data and the third evaluated document data are determined to be close to a desired document, that the fifth evaluated document data is determined not to be close to (to be distant from) the desired document, and that it is difficult to determine whether or not the second evaluated document data and the fourth evaluated document data are close to the desired document.

Incidentally, the number of check boxed in the columns representing the classification 431 that is one of items on the horizontal axis of the table 311, may be one in every row. In such a case, the user preferably checks off a check box in the row belonging to a specific document data when determining the specific document data is close to a desired document. When the user determines the specific document data is not close to (is distant from) the desired document, it is preferable not to check off the check box in the row belonging to the specific document data.

### Step S106

In Step S106, the importance of the tag is inferred from the classification (the second classification) received in Step S105.

The tag subjected to the inference of the importance is preferably at least one tag in the third tag group, further preferably part of the third tag group, still further preferably all the tags in the third tag group. For example, in FIG. 12, at least one of the first tag to the fifth tag is given to each of the first evaluated document data to the fifth evaluated document data. In this case, the tag subjected to the inference of the importance is preferably at least one of the first tag to the fifth tag, further preferably some of the first tag to the fifth tag, still further preferably all of the first tag to the fifth tag.

The inference of the importance of the tag may be performed on a tag not included in the third tag group (a tag different from the first tag to the fifth tag in the example of FIG. 12) besides the above.

The tag subjected to the inference of the importance may be the second tag group. Note that part of the second tag group is not given to any of the evaluated document data groups in some cases. Furthermore, the inference of the importance of the tag may be performed on a tag not included in the second tag group, besides the second tag group.

The tag subjected to the inference of the importance may be the first tag group. Note that part of the first tag group is not given to any of the evaluation document data groups in some cases.

Hereinafter, a tag subjected to the inference of the importance is referred to as a fourth tag group. In the case where the fourth tag group is composed of a plurality of tags, the plurality of tags are subjected to the inference of the importance.

Processing of Step S106a illustrated in FIG. 3D is one of examples of the processing of Step S106. The processing of the Step S106a is to perform learning of a classifier with use of the classification (the second classification) received in Step S105 and the second feature vector of the document data as learning data and to calculate the importance of the tag from the classifier where the learning has been done. A tag whose importance is calculated is the tag subjected to the inference of the importance as described above.

In the document search method la of this embodiment, the first feature vector of the document data can be used as the second feature vector of the document data.

As the learning data, the second feature vector of the evaluated document data and the second classification of the evaluated document data can be used. For example, in the case of p pieces of evaluated document data, p second feature vectors and p types of second classification can be used as the learning data. In this case, the second classification can be used as a learning label.

For example, a neural network is used as the classifier, in which case the importance of the tag is preferably calculated from an intermediate layer included in the neural network. Alternatively, for example, a decision tree is used as a classifier, in which case the importance of the tag is preferably calculated from a Gini coefficient of a branch. Alternatively, for example, Lasso regression or random forest may be used as a classifier for calculation of the importance of the tag.

As illustrated in FIG. 12, after the user conducts the second classification, an icon 305 denoted as “learning” is selected with the mouse pointer 303, whereby learning and inference are carried out. That is, the processing of Step S106 or Step S106a is conducted.

### Step S107

In Step S107, the importance of the tag is output. Furthermore, in Step S107, the importance of the tag is output together with the tag. In other words, in Step S107, the tag and the importance of the tag are output.

The tag output in Step S107 is at least one of the tags subjected to the inference of the importance in Step S106 or Step S106a. That is, the tag output in Step S107 may be some of the tags subjected to the inference of the importance or may be all the tags subjected to the inference of the importance. For example, the tag output in Step S107 may be part of the fourth tag group or all in the fourth tag group. For example, the tag output in Step S107 may be at least one of the first tag to the fifth tag, may be some of the first tag to the fifth tag, or may be all of the first tag to the fifth tag.

A region 320 illustrated in FIG. 13 is a region where the tags and the importance of the tags are displayed. In FIG. 13, a table 321 showing an inference result is displayed in the region 320.

Although the region 320 is placed on the right side of the region 310 in FIG. 13 and FIG. 14, the region 320 may be placed on the left side of the region 310, may be placed between the region 310 and the region 300, or may be placed under the region 310.

FIG. 13 is an example showing an inference result. In the table 321 in FIG. 13, items on the vertical axis each denote a tag 501, and items on the horizontal axis denote importance 511 of the tags and a choice 521, for example.

The tags output to the table 321 are preferably arranged in descending order of importance and displayed. As the arrangement of the tags displayed in FIG. 13, the higher the importance of the tag is, the upper row of the table 321 the tag is positioned in. The table 321 in FIG. 13 shows an example where the importance 511 of the first tag denoted as “a1b1”in the tag 501 is 0.5, the importance 511 of the third tag denoted as “a1b3” in the tag 501 is “0.3”, the importance 511 of the second tag denoted as “a1b2” in the tag 501 is 0.2, the importance 511 of the fourth tag denoted as “a1c1” in the tag 501 is 0.1, and the importance 511 of the fifth tag denoted as “a1c2” in the tag 501 is 0.1.

The arrangement of the tags output to the table 321 is not limited to the descending order of importance. For example, the descending order of frequency of output to the table 311 or the ascending order of importance may be employed for the arrangement of the tags displayed.

In the table 321, a check box is preferably provided in the column whose item on the horizontal axis represents the choice 521. One check box is preferably provided in every row. In the table 321 in FIG. 13, a check box 522 is provided as a check box.

In FIG. 13, the region 300, the region 310, and the region 320 are shown. In the next Step S108, the table 321 displayed in the region 320 is important for selection of a tag by the user. Thus, the number of rows or columns in the table 311 displayed in Step S107 is preferably smaller than the number of rows or columns in the table 311 displayed in Step S105. For example, when the table 311 and the table 321 are arranged side by side, the number of columns in the table 311 displayed in Step S107 is preferably smaller than the number of columns in the table 311 displayed in Step S105. For another example, when the table 311 and the table 321 are arranged vertically, the number of rows in the table 311 displayed in Step S107 is preferably smaller than the number of rows in the table 311 displayed in Step S105.

For example, the table 311 and the table 321 are arranged side by side in FIG. 13. In this case, the document ID 401, the classification 411, the evaluation 421, and the classification 431 are shown as the items on the horizontal axis of the table 311 in FIG. 13. That is, the information 412 and the information 413 are not shown as the items on the horizontal axis.

In the above manner, the range of the region 320 can be ensured sufficiently. Thus, the user can select a tag with reference to the table 311. In addition, the user can determine whether or not a desired result is obtained, as described later, with reference to the table 311.

Here, the user determines whether or not a desired result is obtained. The desired result indicates that a tag used for document search is displayed. When it is determined that the desired result is obtained, the process proceeds to Step S108. When it is determined that the desired result is not obtained, the process returns to Step S105.

### Step S108

In Step S108, at least one tag is received. Also in Step S108, at least one of the tags whose importance is output in Step S107 is received. In other words, at least one of the tags output to the table 321 is received in Step S108.

The user selects a tag in the column whose item on the horizontal axis denotes the choice 521 in the table 321. To select a tag, the user checks off the check box 522 in the row belonging to the tag. Not to select a tag, the user does not check off the check box 522 in the row belonging to the tag.

In FIG. 13, the check box 522 belonging to the first tag is checked off, and the check boxes 522 belonging to the second tag to the fifth tag are not checked off.

### Step S109

In Step S109, a search for a document is performed with use of at least one tag. For example, in Step S109, the tag received in Step S108 is used for a search for a document. In FIG. 13, a search for a document is performed with use of the first tag denoted as “a1b1” in the tag 501.

The user selects the tag, and then selects an icon 306 denoted as “search” with the mouse pointer 303 as illustrated in FIG. 13, whereby a search for a document is performed. That is, the processing of Step S109 is carried out.

Note that the search for a document carried out in Step S109 is referred to as a final search in some cases.

### Step S110

In Step S110, a search result is output.

The user determines whether or not a desired result is obtained. Here, the desired result indicates that a desired document can be retrieved. When it is determined that the desired result has been obtained, the search is terminated. When it is determined that the desired result is not obtained, the process returns to Step S105. When the processing after Step S105 is performed again, the search accuracy can be increased.

Note that a tag with the highest importance is not necessarily used for a search for a desired document. Thus, when it is determined that the desired result is not obtained, the process may return to Step S108. Accordingly, the processing from Step S105 to Step S107 can be omitted, and the time required for a search for a desired document can be shortened.

Consequently, the user can search for a desired document.

In the document search method la of this embodiment, the first feature vector agrees with the second feature vector, so that the amount of arithmetic operation necessary for document search can be reduced. In addition, tags necessary for final search can be reinforced in the same viewpoint.

Although the document search method la of this embodiment shows an example of a document search method in which a search query includes at least one tag, the present invention is not limited to this document search method. The search query does not necessarily include a tag.

### Document Search Method 1b

A document search method 1b of this embodiment shows another example of <Document search method 1> of this embodiment. In the document search method 1b of this embodiment, a search query is one or more words, one or more phrases, one or more sentences, or a combination thereof. In other words, the search query does not include a tag.

Like [Document search method 1a] mentioned above, the document search method 1b of this embodiment includes processing composed of Step S101 to Step S110 shown in FIG. 2. Note that in the description of the document search method 1b of this embodiment, differences from [Document search method 1a] mentioned above are mainly described, and the description of portions similar to those in [Document search method 1a] mentioned above is omitted in some cases.

In the document search method 1b of this embodiment, one or more words, one or more phrases, one or more sentences or combinations thereof are received as a search query. For example, the search query includes at least one word.

In the case where the search query received in Step S102 is one or more words, one or more phrases, or a combination thereof, the vectorization of the search query (processing of Step S122) can be performed. At this time, the search query is vectorized using a word included in the search query.

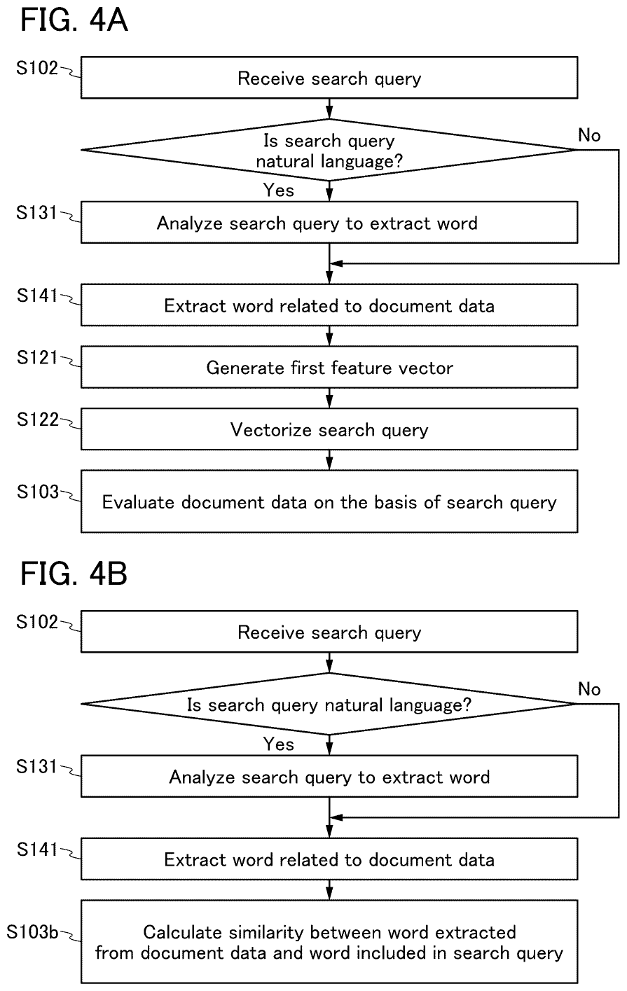

In the case where the search query received in Step S102 includes one or more sentences, it is difficult to vectorize the one or more sentences. Thus, as shown in FIG. 4A, the processing of Step S131 is preferably performed before the processing of Step S122 is performed. The processing of Step S131 is to analyze a search query and to extract at least one word. The vectorization of the search query (the processing of Step S122) can be performed with use of the word extracted in the processing of Step S131. At this time, the search query is vectorized using the word extracted in the processing of Step S131.

A variety of methods can be given for vectorizing one or more sentences (one sentence or text). For example, one or both of morphological analysis and compound word analysis may be performed to divide one or more sentences into phrases or words. Vectorization of the sentence(s) with use of divided words or phrases may be performed.

Examples of the method for vectorizing one or more sentences according to the frequency of word occurrence include TF-IDF (Term Frequency-Inverse Document Frequency) and Bag-of-Words.

Note that one or more words, one or more phrases, or a combination thereof received as the search query in Step S102 may be output to a region 304 illustrated in FIG. 11 to FIG. 14. Alternatively, the word extracted in Step S131 may be output to the region 304. Thus, the user can see the word or phrase used for the evaluation that is the processing of Step S103.

As described above, the search query is vectorized with use of a word included in the search query or a word extracted in the processing of Step S131. Thus, the first feature vector of the document data is preferably generated without using a tag given to the document data. In other words, the first feature vector of the document data is preferably generated with use of at least one word related to the document data.

For example, the first feature vector of the document data is preferably generated with use of the document data. Specifically, the first feature vector of the document data is preferably generated using at least one word extracted from the document data.

When the document data is a patent document, the first feature vector is preferably generated with use of a word extracted from at least one of a specification, an abstract, and a scope of claims, for example. When the document data is an academic paper, a novel, or the like, the first feature vector is preferably generated with use of a word extracted from a main text of the document, for example.

Furthermore, the first feature vector of the document data may be generated using at least one of pieces of information related to the document data, other than the first classification, for example. Specifically, the first feature vector of the document data may be generated with use of at least one word extracted from one or more sentences included in at least one of the pieces of information related to the document data.

In the case where each of a plurality of pieces of document data does not include the first feature vector, it is preferable to include processing of Step S121 between the processing of Step S101 and the processing of Step S103 as shown in FIG. 4A.

In Step S121, the first feature vector of the document data is preferably generated with use of the document data. Furthermore, when the document data used for generating the first feature vector includes one or more sentences, the processing of Step S141 is preferably performed before the processing of Step S121 is performed. The timing before the processing of Step S121 is performed is, for example, the timing between the processing of Step S101 and the processing of Step S103. In Step S141, a word is extracted from the document data. Specifically, it is preferable that one or both of morphological analysis and compound word analysis be performed to divide one or more sentences included in the document data into words or phrases and extract the word.

Alternatively, the first feature vector of the document data is preferably generated with use of at least one of words extracted from at least one of pieces of information related to the document data, other than the first classification. When at least one of the pieces of information related to the document data used for generating the first feature vector includes one or more sentences, the processing of Step S141 is preferably performed before the processing of Step S121 is performed. For example, in Step S141, a word is extracted from at least one of the pieces of information related to the document data. Specifically, it is preferable that one or both of morphological analysis and compound word analysis be performed to divide one or more sentences included in at least one of the pieces of information related to the document data into words or phrases and extract the word.

In the document search method 1b of this embodiment, the first feature vector is generated with use of a word. The second feature vector is generated with use of a tag. For example, the second feature vector of the document data is generated with use of a tag given to the document data. Thus, the first feature vector of the document data is different from the second feature vector of the document data. Note that for the second feature vector in the document search method 1b of this embodiment, the first feature vector described above in [Document search method 1a] can be referred to.

In the document search method 1b of this embodiment, a tag that is effective in searching for a desired document can be obtained even when a tag necessary for searching for the desired document is not figured out.

For the display method of the document search result, the above description in <Document search method 1> can be referred to. Note that a word related to document data is preferably output to the classification 411 shown in the table 311 in FIG. 12 and FIG. 13 and the classification 411 shown in the table 312 in FIG. 14.

### Document Search Method 1c

A document search method 1c of this embodiment is another example of the document search method 1b described above.

Like [Document search method 1a] mentioned above, the document search method 1c of this embodiment includes processing composed of Step S101 to Step S110 shown in FIG. 2. Note that in the description of the document search method 1c of this embodiment, differences from [Document search method 1b] mentioned above are mainly described, and the description of portions similar to those in [Document search method 1a] or [Document search method 1b] mentioned above is omitted in some cases.

In [Document search method 1c] of this embodiment, one or more words, one or more phrases, one or more sentences, or a combination thereof are received as a search query.

Here, in the case where the search query received in Step S102 includes one or more sentences, the above-described processing of Step S131 is preferably performed.

As Step S103 shown in FIG. 2, processing of Step S103b shown in FIG. 4B is preferably performed. The processing of Step S103b is to calculate the matching degree between the word extracted by the processing of Step S141 and the word included in the search query or the word extracted by the processing of Step S131, for each of the plurality of pieces of document data received in Step S101.

In the document search method 1c of this embodiment, the first feature vector is not generated, and the second feature vector is generated with use of a tag. Thus, in the document search method 1c of this embodiment, processing for generating the first feature vector can be omitted. In addition, the vectorization of the search query is not necessarily performed. Thus, the amount of arithmetic operation necessary for document search can be reduced.

For the display method of the document search result, the above description in <Document search method 1> can be referred to. Note that a word related to document data is preferably output to the classification 411 shown in the table 311 in FIG. 12 and FIG. 13 and the classification 411 shown in the table 312 in FIG. 14.

### Variation

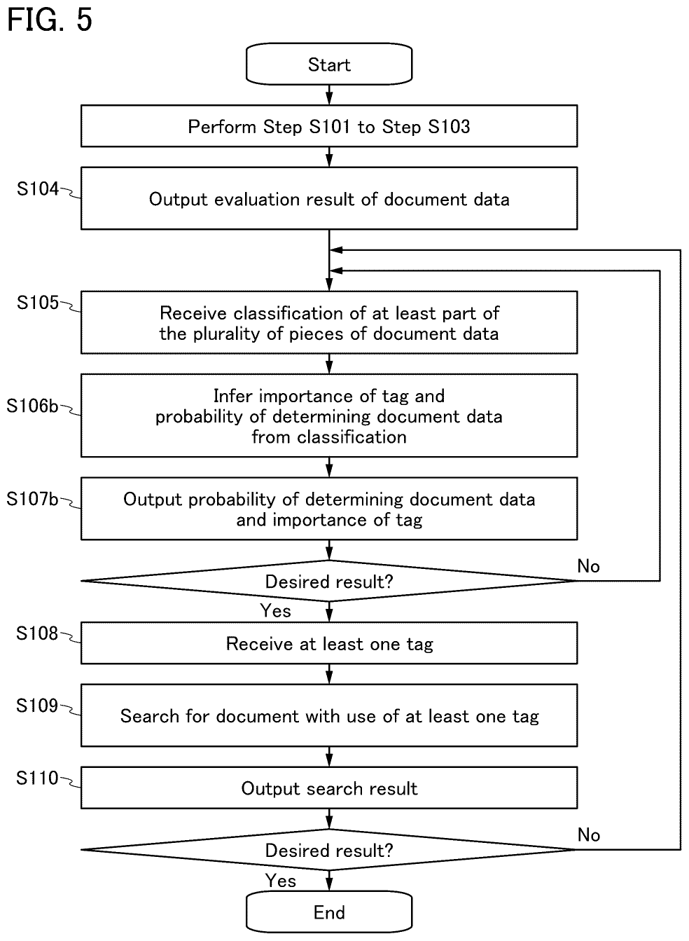

In <Document search method 1> of this embodiment, part of the processing shown in FIG. 2 may be changed. FIG. 5 is another example of <Document search method 1> of this embodiment. The document search method shown in FIG. 5 is different from <Document search method 1> exemplified with FIG. 2 in that processing of Step S106b and Step S107b is carried out instead of the processing of Step S106 and Step S107.

In the description of Step S106b, the description of portions similar to those in Step S106 or Step S106a mentioned above is omitted in some cases. In the description of Step S107b, the description of portions similar to those in Step S107 mentioned above is omitted in some cases.

Since Step S101 to Step S105 shown in FIG. 5 are the same as Step S101 to Step S105 shown in FIG. 2, the above description can be referred to.

### Step S106b

In Step S106b, the importance of the tag and the probability of determining the document data are inferred from the classification (the second classification) received in Step S105.

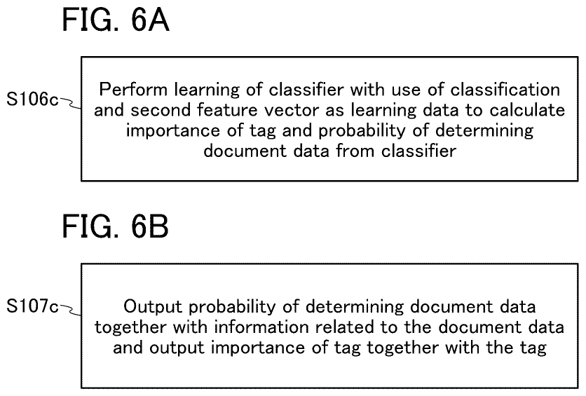

Processing of Step S106c shown in FIG. 6A is an example of the processing of Step S106b. The processing of Step S106c is to perform learning of a classifier using the classification (the second classification) received in Step S105 and the second feature vector of the document data as learning data and to calculate the importance of the tag and the probability of determining the document data from the classifier where the learning has been done.

The probability of determining the document data is preferably calculated on the basis of data output from the classifier. That is, the determining probability can be regarded as evaluation of the document data reflecting the classification (the second classification) received in Step S105. In other words, the determining probability can be regarded as the similarity or distance between the search query and the document data reflecting the second classification.

### Step S107b

In Step S107b, the probability of determining the document data and the importance of the tag are output.

The document data whose determining probability is output is at least one of pieces of the document data output in Step S104. That is, the document data whose determining probability is output may be part of the plurality of pieces of the document data output in Step S104 or all pieces of the document data output in Step S104. For example, the probability of determining the evaluated document data group (p pieces of evaluated document data) is preferably displayed in Step S107b.

As another example of <Document search method 1> shown in FIG. 5 may include processing of Step S107c shown in FIG. 6B instead of the processing of Step S107b. In Step S107c, the probability of determining the document data and the importance of the tag are output. In Step S107c, the probability of determining the document data is output together with information related to the document data, and the importance of the tag is output together with the tag.

FIG. 14 is another example showing an inference result. In FIG. 14, the table 312 showing the determining probability calculated in Step S107 is output instead of the table 311 showing the evaluation result obtained in Step S103. In the table 312 in FIG. 14, items on the vertical axis each denote the document ID 401, and items on the horizontal axis denote the classification 411, a determining probability 441, and the classification 431, for example.

The pieces of document data output and displayed to/on the table 312 in FIG. 14 are preferably arranged in descending order of determining probability. In FIG. 14, the pieces of document data are displayed so that the higher determining probability the document data has, the upper row in the table 312 the document data is positioned. FIG. 14 shows an example where the probability 441 of determining the first evaluated document data is 0.9, the probability 441 of determining the third evaluated document data is 0.8, the probability 441 of determining the second evaluated document data is 0.5, the probability 441 of determining the fourth evaluated document data is 0.3, and the probability 441 of determining the fifth evaluated document data is 0.1. That is, in FIG. 14, the first evaluated document data, the third evaluated document data, the second evaluated document data, the fourth evaluated document data, and the fifth evaluated document data are displayed in this order from the above.

Note that the order of displaying the pieces of document data output to the table 312 may be the numerical order of the document ID 401 or the ascending order of determining probability.

Note that the table 321 in FIG. 14 is similar to the table 321 in FIG. 14.

The table 312 in FIG. 14 can be regarded as an evaluation result of the document data reflecting the classification (the second classification) received in Step S105. Accordingly, when it is determined that a desired result is not obtained and the process returns to Step S105, the classification in Step S105 is conducted again with reference to the table 312 in FIG. 14. Through such a process, the accuracy of the classifier can be enhanced.

Since Step S108 to Step S110 shown in FIG. 5 are respectively the same as Step S108 to Step S110 shown in FIG. 2, the above description can be referred to.

The above is the description of the document search method where a search for a document is performed with use of a tag.

### Document Search Method 2

In <Document search method 2> of this embodiment, a document search method where a search for a document is performed with use of a word is described. <Document search method 2> of this embodiment is effective in a search for a document to which the classification (the above-described first classification) is not given.

For the display method of a document search result, the above description in <Document search method 1> can be referred to. In <Document search method 2> of this embodiment, a word whose importance has been inferred is preferably output to the tag 501 shown in the table 321 in FIG. 13 and FIG. 14. Also, to the importance 511 of the tag shown in the table 321 in FIG. 13 and FIG. 14, the importance of the word is preferably output.

### Document Search Method 2a

A document search method 2a of this embodiment shows an example of <Document search method 2>. Note that in the document search method 2a of this embodiment, a search query includes at least one tag. The tag may be a code or a keyword.

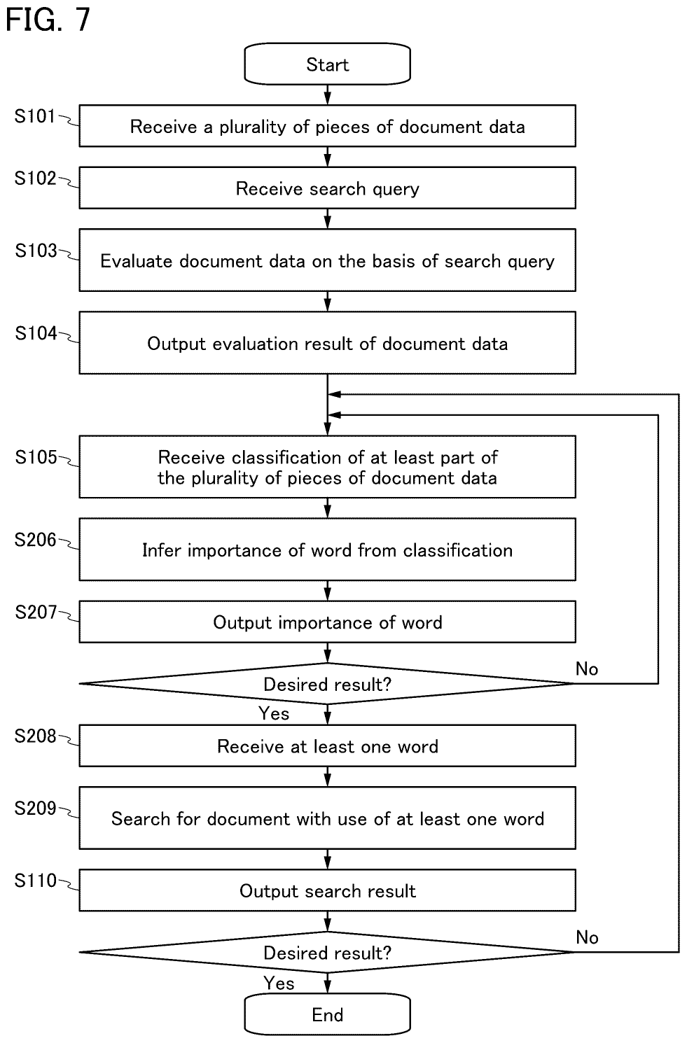

The document search method 2a of this embodiment includes the processing of Step S101 to Step S105, Step S206 to Step S209, and Step S110 shown in FIG. 7.

Since Step S101 to Step S105 shown in FIG. 7 are respectively the same as Step S101 to Step S105 shown in FIG. 2, the above description in [Document search method 1a] can be referred to.

The above-described processing of Step S141 is preferably performed before the processing of Step S206 is carried out. The document data subjected to the processing of Step S141 is preferably an evaluated document data group. Furthermore, the document data subjected to the processing of Step S141 may be a document data group. The processing of Step S141 enables a word related to the document data to be extracted. The set (sum of sets) of all of the words extracted in Step S141 is referred to as a first word group.

After the processing of Step S141, the second feature vector of the document data is preferably generated. The second feature vector of the document data is preferably generated with use of a word related to the document data obtained in Step S141. For example, the second feature vector of the document data is preferably generated with use of a word extracted from the document data.

### Step S206

In Step S206, the importance of the word is inferred from the classification (the second classification) received in Step S105. Note that in the description of Step S206, the description of [Document search method 1a] can be referred to for portions similar to those in Step S106. In that case, the “tag” described in [Document search method 1a] is preferably replaced with the “word”.

A word whose importance is inferred is preferably at least one of words in the first word group, further preferably part of the first word group, and still further preferably all the words in the first word group. For example, at least one of the words extracted from the p pieces of evaluated document data is preferable; some of the words extracted from the p pieces of evaluated document data is further preferable; all the words extracted from the p pieces of evaluated document data is still further preferable. For example, at least one of the words extracted from at least one of pieces of information related to the p pieces of evaluated document data is preferable; some of the words extracted from one of the pieces of information related to the p pieces of evaluated document data is further preferable; all the words extracted from at least one of the pieces of information related to the p pieces of evaluated document data is still further preferable.

Hereinafter, words whose importance is inferred are referred to as a second word group. When all of the words in the first word group is subjected to the inference of the importance, the second word group is the same as the first word group. When part of the first word group is subjected to the inference of the importance, the second word group is the subset of the first word group. When the second word group is composed of a plurality of words, the plurality of words are subjected to the inference of the importance.

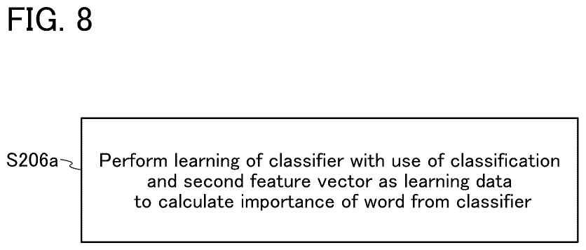

Processing of Step S206a shown in FIG. 8 is an example of the processing of Step S206. The processing of Step S206a is to perform learning of a classifier using the classification (the second classification) received in Step S105 and the second feature vector of the document data as learning data and to calculate the importance of a word from the classifier where the learning has been done. A word whose importance is calculated corresponds to the word whose importance is inferred as described above.

As the learning data, the second feature vector of the evaluated document data and the second classification of the evaluated document data can be used. For example, as the learning data, the second feature vector and the second classification of each of the p pieces of evaluated document data can be used. In that case, the second classification can be used as a learning label.

For example, in the case where a neural network is used as the classifier, the importance of a word is preferably calculated from an intermediate layer included in the neural network. Alternatively, for example, in the case where a decision tree is used as a classifier, the importance of a word is preferably calculated from a Gini coefficient of a branch. Alternatively, for example, Lasso regression or random forest may be used as a classifier for calculation of the importance of a word.

In the document search method 2a of this embodiment, the first feature vector is generated with use of a tag, and the second feature vector is generated with use of a word. Thus, the first feature vector of specific document data is different from the second feature vector of the corresponding document data.

### Step S207

In Step S207, the importance of a word is output. In Step S107, the importance of a word is output together with the word. In other words, a word and the importance of the word are output in Step S207. Note that in the description of Step S207, the above description in [Document search method 1a] can be referred to for portions similar to those in Step S107. In that case, the “tag” described in [Document search method 1a] is preferably replaced with the “word”.

The word output in Step S207 is at least one of the words subjected to the importance inference in Step S206 or Step S206a. That is, the word output in Step S207 may be some of the words subjected to the importance inference or may be all the words subjected to the importance inference. For example, the word output in Step S207 may be some of the words in the second word group or all the words in the second word group.

Note that the output of the word in Step S207 is not limited to the table format shown in FIG. 13. For example, words can be output to have sizes varying in proportion to a value of the importance as in a word cloud. Furthermore, words can be output so that a word with a higher value of the importance is positioned centrally. The output in such a manner enables the user to recognize the importance of the word visually. Note that the word cloud is also referred to as a tag cloud or a weighted list.

At this point, the user determines whether or not a desired result is obtained. The desired result here indicates that a word used for a document search is displayed. When it is determined that the desired result is obtained, the process proceeds to Step S208. When it is determined that the desired result is not obtained, the process returns to Step S105.

### Step S208

In Step S208, at least one word is received. In Step S208, at least one of the words whose importance is output in Step S207 is also received. In other words, at least one of the words output to the table 321 is received in Step S208. Note that in the description of Step S208, the above description of [Document search method 1a] can be referred to for portions similar to those in Step S108. In that case, the “tag” described in [Document search method 1a] is preferably replaced with the “word”.

In the case where the words are output in the word cloud format in Step S207, the word may be selected directly without providing a check box. If the selected word is highlighted in such a case, the visibility of the selected word can be enhanced. For example, a selected word can be highlighted by underlining the word, thickening the line of a character, using a color for the word different from a color for other characters, highlighting the word with a marker, or the like.

### Step S209

In Step S209, a search for a document is performed with use of at least one word. For example, in Step S209, a search for a document is performed with use of the word received in Step S208. Note that in the description of Step S209, the above description of [Document search method 1a] can be referred to for portions similar to those in Step S109. In that case, the “tag” described in [Document search method 1a] is preferably replaced with the “word”.

Since Step 110 shown in FIG. 7 is the same as Step 110 shown in FIG. 2, the above description in [Document search method 1a] can be referred to.

Through the above processing, the user can search for a desired document.

In the document search method 2a of this embodiment, a word that is effective in searching for a desired document can be obtained even when a word necessary for searching for the desired document is not figured out.

Although the document search method 2a of this embodiment exemplifies a document search method in which the search query includes at least one tag, the present invention is not limited to this method. The search query does not necessarily include a tag.

### Document Search Method 2b

A document search method 2b of this embodiment shows another example of <Document search method 2> of this embodiment. In the document search method 2b of this embodiment, a search query is one or more words, one or more phrases, one or more sentences, or a combination thereof. In other words, the search query does not include a tag.

Like [Document search method 2a] mentioned above, the document search method 2b of this embodiment includes processing composed of Step S101 to Step S105, Step S206 to Step S209, and Step S110 shown in FIG. 7.

Note that for Step S101 to Step S105 shown in FIG. 7 in the document search method 2b of this embodiment, the above description in [Document search method 1b] can be referred to.

For Step S206 to Step S209 shown in FIG. 7 in the document search method 2b of this embodiment, the above description in [Document search method 2a] can be referred to.

For Step S110 shown in FIG. 7 in the document search method 2b of this embodiment, the above description in [Document search method 1a] can be referred to.

In the document search method 2b of this embodiment, each of the first feature vector and the second feature vector is generated with use of a word. That is, as the second feature vector of the document data, the first feature vector of the document data can be used. In this case, it can be said that the first feature vector of the document data agrees with the second feature vector of the document data.

In the document search method 2b of this embodiment, the first feature vector agrees with the second feature vector, so that the amount of arithmetic operation necessary for document search can be reduced. In addition, words necessary for final search can be reinforced in the same viewpoint.

### Document Search Method 2c

A document search method 2c of this embodiment shows another example of the document search method 2b described above.

Like [Document search method 2a] mentioned above, the document search method 2c of this embodiment includes processing composed of Step S101 to Step S105, Step S206 to Step S209, and Step S110 shown in FIG. 7.

Note that for Step S101 to Step S105 shown in FIG. 7 in the document search method 2c of this embodiment, the above description in [Document search method 1c] can be referred to.

For Step S206 to Step S209 shown in FIG. 7 in the document search method 2c of this embodiment, the above description in [Document search method 2a] can be referred to.

For Step S110 shown in FIG. 7 in the document search method 2c of this embodiment, the above description in [Document search method 1a] can be referred to.

In the document search method 2c of this embodiment, the first feature vector is not generated, and the second feature vector is generated with use of a word. Thus, in the document search method 2c of this embodiment, processing for generating the first feature vector can be omitted. In addition, the vectorization of the search query is not necessarily performed. Accordingly, the amount of arithmetic operation necessary for document search can be reduced.

### Variation

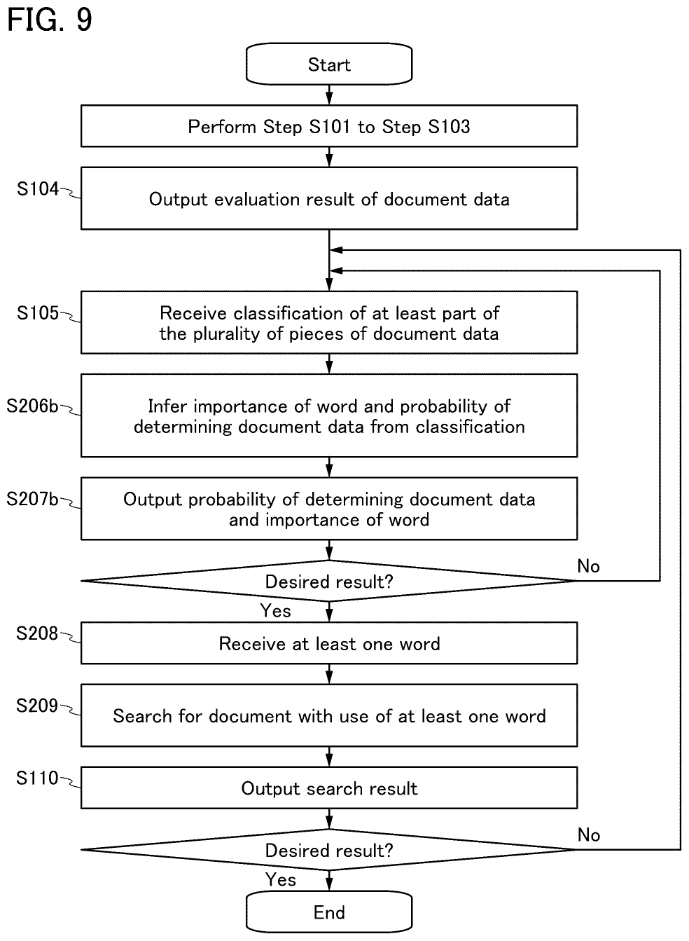

In <Document search method 2> of this embodiment, part of the processing shown in FIG. 7 may be changed. FIG. 9 shows another example of <Document search method 2> of this embodiment. <Document search method 2> shown in FIG. 9 is different from <Document search method 2> exemplified with FIG. 7 in that processing of Step S206b and Step S207b is carried out instead of processing of Step S206 and Step S207.

In the description of Step S206b, the description of portions similar to those in Step S206 or Step S206a described above is omitted in some cases. In addition, in the description of S207b, the description of portions similar to those in Step S207 or Step S207a described above is omitted in some cases.

Since Step S101 to Step S105 shown in FIG. 9 are respectively the same as Step S101 to Step S105 shown in FIG. 7, the above description in <Document search method 1> and the above description in [Document search method 2a] can be referred to.

### Step S206b

In Step S206b, the importance of a word and the probability of determining the document data are inferred from the classification (the second classification) received in Step S105.

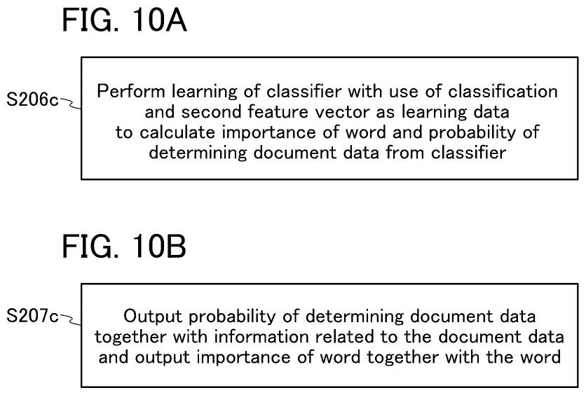

As an example of the processing of Step S206b, processing of Step S206c shown in FIG. 10A can be given. The processing of Step S206c is to perform learning of a classifier using the classification (the second classification) received in Step S105 and the second feature vector of the document data as learning data and to calculate the importance of a word and the probability of determining the document data from the classifier where the learning has been done.

### Step S207b

In Step S207b, the probability of determining the document data and the importance of the word are output.

The document data whose determining probability is output is at least one of pieces of the document data output in Step S104. That is, the document data whose determining probability is output may be part of the plurality of pieces of the document data output in Step S104 or all pieces of the document data output in Step S104. For example, the determining probability of the evaluated document data group (p pieces of evaluated document data) is preferably displayed in Step S207b.

As another example of <Document search method 2> shown in FIG. 9, processing of Step S207c shown in FIG. 10B may be included instead of Step S207b. In Step S207c, the probability of determining the document data and the importance of the word are output. In Step S207c, the probability of determining the document data is output together with information related to the document data, and the importance of the word is output together with the word.

Since Step S208, Step S209, and Step S110 shown in FIG. 9 are respectively the same as Step S208, Step S209, and Step S110 shown in FIG. 7, the description in <Document search method 1> and the description in [Document search method 2a] can be referred to.

The above is the description of the document search method where a search for a document is performed with use of a word.

As described above, the document search system of this embodiment can provide a tag or word that is preferably used for a search query of document search. Since the tag or word provided by the document search system is presented by an inference based on user's evaluation results, it is possible to obtain an appropriate query where noise is more lowered than that in a search query which the user inputs to the document search system.

Thus, with use of the document search system and the document search method of this embodiment, a search that is of intuitive and efficient for the user can be performed. Even in the case of a large number of documents as a search target, a desired document can be obtained in a short time.

This embodiment can be combined with any of the other embodiments as appropriate. In the case where a plurality of structure examples are shown in one embodiment in this specification, the structure examples can be combined as appropriate.

### Embodiment 2

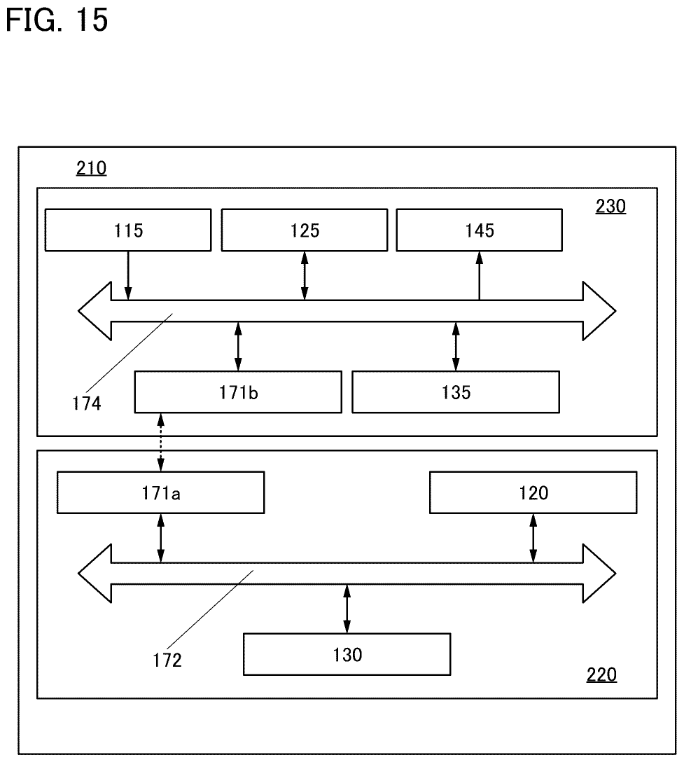

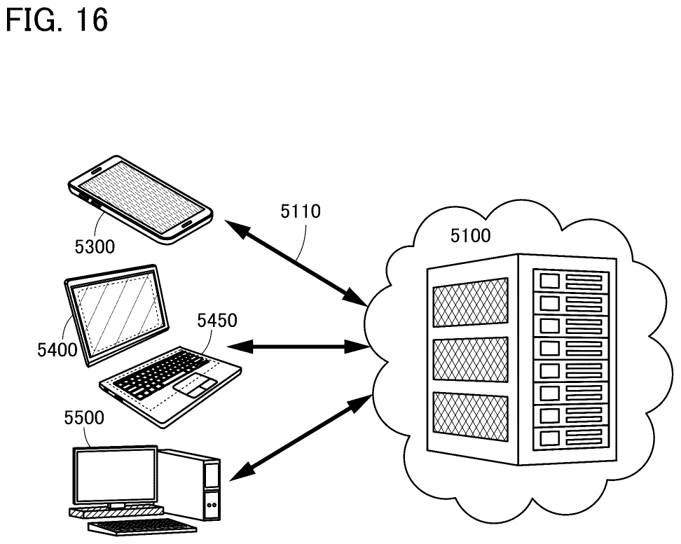

In this embodiment, a document search system of one embodiment of the present invention will be described with reference to FIG. 15 and FIG. 16.

### Document Search System 2

FIG. 15 shows a block diagram of a document search system 210. The document search system 210 includes a server 220 and a terminal 230 (e.g., a personal computer). Note that the description of <Document search system 1> in Embodiment 1 can be referred to for the same components as those in the document search system 100 shown in FIG. 1.

The server 220 includes a communication unit 171a, a transmission path 172, the storage unit 120, and the processing unit 130. Although not shown in FIG. 15, the server 220 may further include at least one of a reception unit, a database, an output unit, an input unit, and the like.

The terminal 230 includes a communication unit 171b, a transmission path 174, an input unit 115, a storage unit 125, a processing unit 135, and a display unit 145. Examples of the terminal 230 include a tablet terminal, a laptop information terminal, and a variety of portable information terminals. The terminal 230 may be a desktop information terminal without the display unit 145 and may be connected to a monitor functioning as the display unit 145, or the like.

A user of the document search system 210 inputs document data from the input unit 115 of the terminal 230 to the server 220. A search query can also be input. These input contents are transmitted from the communication unit 171b to the communication unit 171a. For example, the document data and the search query are transmitted from the communication unit 171b to the communication unit 171a.

The information received by the communication unit 171a is stored in a memory included in the processing unit 130 or the storage unit 120 via the transmission path 172. The information may be supplied from the communication unit 171a to the processing unit 130 via a reception unit (see the reception unit 110 illustrated in FIG. 1).

The processing of Step S103 and Step S106 described in <Document search method 1> in Embodiment 1, the processing of Step S206 described in <Document search method 2> in Embodiment 1, and the like are conducted in the processing unit 130. These kinds of processing require high processing capacity, and thus are preferably performed in the processing unit 130 included in the server 220. The processing unit 130 preferably has higher processing capacity than the processing unit 135.

A processing result of the processing unit 130 is stored in the memory included in the processing unit 130 or the storage unit 120 via the transmission path 172. After that, the processing result is output from the server 220 to the display unit 145 of the terminal 230. The processing result is transmitted from the communication unit 171a to the communication unit 171b. On the basis of the processing result of the processing unit 130, various kinds of data contained in a database may be transmitted from the communication unit 171a to the communication unit 171b. The processing result may be supplied from the processing unit 130 to the communication unit 171a via an output unit (the output unit 140 illustrated in FIG. 1).

### Communication Unit 171a and Communication Unit 171b

The server 220 and the terminal 230 can transmit and receive data with use of the communication unit 171a and the communication unit 171b. As the communication unit 171a and the communication unit 171b, a hub, a router, a modem, or the like can be used. Data may be transmitted and received through wire communication or wireless communication (e.g., radio waves or infrared rays).

### Transmission Path 172 and Transmission Path 174

The transmission path 172 and the transmission path 174 have a function of transmitting data. The communication unit 171a, the storage unit 120, and the processing unit 130 can transmit and receive data via the transmission path 172. The communication unit 171b, the input unit 115, the storage unit 125, the processing unit 135, and the output unit 140 can transmit and receive data via the transmission path 174.

### Input Unit 115

The input unit 115 can be used when the user designates a document group and a search query. For example, the input unit 115 can have a function of operating the terminal 230; specific examples thereof include a mouse, a keyboard, a touch panel, a microphone, a scanner, and a camera.

The document search system 210 may have a function of converting audio data into text data. For example, at least one of the processing unit 130 and the processing unit 135 may have this function.

The document search system 210 may have an optical character recognition (OCR) function. This enables characters contained in image data to be recognized and text data to be created. For example, at least one of the processing unit 130 and the processing unit 135 may have this function.

### Storage Unit 125

The storage unit 125 may store one or both of the data on the document and the data supplied from the server 220. The storage unit 125 may include at least part of the data that can be included in the storage unit 120.

### Processing Unit 130 and Processing Unit 135

The processing unit 135 has a function of performing arithmetic operation or the like with use of data supplied from the communication unit 171b, the storage unit 125, the input unit 115, or the like. The processing unit 135 may have a function of executing at least part of processing that can be performed by the processing unit 130.

Each of the processing unit 130 and the processing unit 135 can include one or both of a transistor including a metal oxide in its channel formation region (OS transistor) and a transistor including silicon in its channel formation region (Si transistor).

In this specification and the like, a transistor including an oxide semiconductor or a metal oxide in a channel formation region is referred to as an oxide semiconductor transistor or an OS transistor. A channel formation region of an OS transistor preferably includes a metal oxide.

In this specification and the like, a metal oxide is an oxide of a metal in a broad sense. Metal oxides are classified into an oxide insulator, an oxide conductor (including a transparent oxide conductor), an oxide semiconductor (also simply referred to as an OS), and the like. For example, in the case where a metal oxide is used in a semiconductor layer of a transistor, the metal oxide is referred to as an oxide semiconductor in some cases. That is, when a metal oxide can form a channel formation region of a transistor that has at least one of an amplifying function, a rectifying function, and a switching function, the metal oxide can be referred to as a metal oxide semiconductor or shortly as an OS.

The metal oxide included in the channel formation region preferably contains indium (In). When the metal oxide included in the channel formation region is a metal oxide containing indium, the carrier mobility (electron mobility) of the OS transistor is high. The metal oxide included in the channel formation region is preferably an oxide semiconductor containing an element M. The element Mis preferably at least one of aluminum (Al), gallium (Ga), and tin (Sn). Other elements that can be used as the element M are boron (B), silicon (Si), titanium (Ti), iron (Fe), nickel (Ni), germanium (Ge), yttrium (Y), zirconium (Zr), molybdenum (Mo), lanthanum (La), cerium (Ce), neodymium (Nd), hafnium (Hf), tantalum (Ta), tungsten (W), and the like. Note that a combination of two or more of the above elements may be used as the element M. The element M is, for example, an element that has high bonding energy with oxygen. The element M is, for example, an element that has higher bonding energy with oxygen than that of indium. The metal oxide included in the channel formation region is preferably a metal oxide containing zinc (Zn). The metal oxide containing zinc is easily crystallized in some cases.

The metal oxide included in the channel formation region is not limited to the metal oxide containing indium. The semiconductor layer may be a metal oxide that does not contain indium and contains zinc, a metal oxide that does not contain indium and contains gallium, a metal oxide that does not contain indium and contains tin, or the like, e.g., zinc tin oxide or gallium tin oxide.

The processing unit 130 preferably includes an OS transistor. The OS transistor has an extremely low off-state current; thus, with use of the OS transistor as a switch for retaining electric charge (data) that has flowed into a capacitor functioning as a storage element, a long data retention period can be ensured. When at least one of a register and a cache memory included in the processing unit 130 has such a feature, the processing unit 130 can be operated only when needed, and otherwise can be off while data processed immediately before turning off the processing unit 130 is stored in the storage element. In other words, normally-off computing is possible and the power consumption of the document search system can be reduced. The same applies to the processing unit 135.

### Display Unit 145

The display unit 145 has a function of displaying an output result. Examples of the display unit 145 include display devices such as a liquid crystal display device and a light-emitting display device. Examples of light-emitting elements that can be used in the light-emitting display device include an LED (Light Emitting Diode), an OLED (Organic LED), a QLED (Quantum-dot LED), and a semiconductor laser. It is also possible to use, as the display unit 145, a display device using a MEMS (Micro Electro Mechanical Systems) shutter element, an optical interference type MEMS element, or a display device using a display element employing a microcapsule method, an electrophoretic method, an electrowetting method, an Electronic Liquid Powder (registered trademark) method, or the like, for example.

FIG. 16 is a conceptual diagram of the document search system of this embodiment.

The document search system illustrated in FIG. 16 includes a server 5100 and terminals (also referred to as electronic devices). Communication between the server 5100 and each terminal is conducted via an Internet connection 5110.

The server 5100 is capable of performing arithmetic operation using data input from the terminal via the Internet connection 5110. The server 5100 is capable of transmitting an arithmetic operation result to the terminal via the Internet connection 5110. Accordingly, the burden of arithmetic operation on the terminal can be reduced.

In FIG. 16, an information terminal 5300, an information terminal 5400, and an information terminal 5500 are shown as the terminals. The information terminal 5300 is an example of a portable information terminal such as a smartphone. The information terminal 5400 is an example of a tablet terminal. When the information terminal 5400 is connected to a housing 5450 with a keyboard, the information terminal 5400 can be used as a laptop information terminal. The information terminal 5500 is an example of a desktop information terminal.

With such a structure, the user can access the server 5100 from the information terminal 5300, the information terminal 5400, the information terminal 5500, and the like. Then, through the communication via the Internet connection 5110, the user can receive a service offered by an administrator of the server 5100. Examples of the service include a service with use of the document search method of one embodiment of the present invention. In the service, artificial intelligence may be utilized in the server 5100.

This embodiment can be combined with the other embodiment as appropriate.

### REFERENCE NUMERALS

100: document search system, 110: reception unit, 115: input unit, 120: storage unit, 125: storage unit, 130: processing unit, 135: processing unit, 140: output unit, 145: display unit, 150: transmission path, 171a: communication unit, 171b: communication unit, 172: transmission path, 174: transmission path, 210: document search system, 220: server, 230: terminal, 300: region, 301: region, 302: icon, 303: mouse pointer, 304: region, 305: icon, 306: icon, 310: region, 311: table, 312: table, 320: region, 321: table, 401: document ID, 411: classification, 412: information, 413: information, 421: evaluation, 431: classification, 432: first check box, 433: second check box, 441: determining probability, 501: tag, 511: importance, 521: choice, 522: check box, 5100: server, 5110: Internet connection, 5300: information terminal, 5400: information terminal, 5450: housing, 5500: information terminal

1. A document search method comprising:
a first step of receiving a plurality of pieces of document data;
a second step of receiving a search query;
a third step of evaluating each of the plurality of pieces of document data on the basis of the search query;
a fourth step of outputting an evaluation result of at least a part of the plurality of pieces of document data;
a fifth step of receiving classification of at least the part of the plurality of pieces of document data;
a sixth step of inferring importance of each of a plurality of tags from the classification;
a seventh step of outputting the importance of at least a part of the plurality of tags;
an eighth step of receiving at least one of the tags whose importance is output in the seventh step; and
a ninth step of searching for a document with use of the tag received in the eighth step.

2. The document search method according to claim 1,
wherein each of the plurality of pieces of document data is given at least one tag,
wherein the search query comprises at least one tag,
wherein the document search method further comprises a step of generating a feature vector for each of the plurality of pieces of document data with use of the tag given to the document data between the first step and the third step,
wherein the document search method further comprises a step of vectorizing the search query with use of the tag in the search query between the second step and the third step, and
wherein in the third step, a similarity between the feature vector and the vectorized search query is calculated for each of the plurality of pieces of document data.

3. The document search method according to claim 2,
wherein in the sixth step, learning of a classifier is performed with use of the classification and the feature vector as learning data to calculate the importance of each of the plurality of tags from the classifier.

4. The document search method according to claim 1,
wherein the search query comprises at least one word,
wherein the document search method further comprises a step of generating a first feature vector for each of the plurality of pieces of document data with use of a word extracted from the document data between the first step and the third step,
wherein the document search method further comprises a step of vectorizing the search query with use of the word in the search query between the second step and the third step, and
wherein in the third step, a similarity between the first feature vector and the vectorized search query is calculated for each of the plurality of pieces of document data.

5. The document search method according to claim 4,
wherein each of the plurality of pieces of document data is given at least one tag,
wherein in the sixth step, learning of a classifier is performed with use of the classification and a second feature vector as learning data to calculate the importance of each of the plurality of tags from the classifier, and
wherein the second feature vector of the document data is generated with use of the tag given to the document data.

6. The document search method according to claim 1,
wherein the inference in the sixth step comprises a calculation of a probability of determining the document data, and
wherein in the seventh step, the probability of determining the document data is further output.

7. A document search method comprising:
a first step of receiving a plurality of pieces of document data;
a second step of receiving a search query;
a third step of evaluating each of the plurality of pieces of document data on the basis of the search query;
a fourth step of outputting an evaluation result of at least a part of the plurality of pieces of document data;
a fifth step of receiving classification of at least the part of the plurality of pieces of document data;
a sixth step of inferring importance of each of a plurality of words from the classification;
a seventh step of outputting the importance of at least a part of the plurality of words;
an eighth step of receiving at least one of the words whose importance is output in the seventh step; and
a ninth step of searching for a document with use of the word received in the eighth step.

8. The document search method according to claim 7,
wherein the search query comprises at least one word,
wherein the document search method further comprises a step of extracting a word from each of the plurality of pieces of document data between the first step and the third step, and
wherein in the third step, a similarity between the word extracted and a word in the search query is calculated for each of the plurality of pieces of document data.

9. The document search method according to claims 8,
wherein in the sixth step, learning of a classifier is performed with use of the classification and the word extracted as learning data to calculate the importance of each of the plurality of words from the classifier.

10. The document search method according to claim 7,
wherein each of the plurality of pieces of document data is given at least one tag,
wherein the search query comprises at least one tag,
wherein the document search method further comprises a step of generating a first feature vector for each of the plurality of pieces of document data with use of the tag given to the document data between the first step and the third step,
wherein the document search method further comprises a step of vectorizing the search query with use of the tag in the search query between the second step and the third step, and
wherein in the third step, a similarity between the first feature vector and the vectorized search query is calculated for each of the plurality of pieces of document data.

11. The document search method according to claim 10,
wherein in the sixth step, learning of a classifier is performed with use of the classification and a second feature vector as learning data to calculate the importance of each of the plurality of words from the classifier, and
wherein the second feature vector of the document data is generated with use of a word extracted from the document data.

12. The document search method according to claim 7,
wherein the inference in the sixth step comprises a calculation of a probability of determining the document data, and
wherein in the seventh step, the probability of determining the document data is further output.

13. A document search system comprising:
a reception unit, a processing unit, and an output unit,
wherein the reception unit is configured to receive document data, a search query, classification, and a tag,
wherein the processing unit is configured to evaluate the document data on the basis of the search query and configured to infer importance of the tag from the classification, and
wherein the output unit is configured to output an evaluation result of the document data and configured to output the importance of the tag.

14. The document search system according to claim 13,
wherein the document data is given at least one tag,
wherein the document data comprises a feature vector generated with use of the tag given to the document data, and
wherein the processing unit is configured to vectorize the search query and configured to calculate a similarity between the vectorized search query and the feature vector.

15. The document search system according to claim 14, further comprising a storage unit,
wherein a classifier is stored in the storage unit, and
wherein the processing unit is configured to perform learning of the classifier with use of the classification and the feature vector as learning data and configured to calculate the importance of the tag from the classifier.
